(19) United States
(12) Patent Application Publication
(10) Pub. No.: US 2002/0052824 A1
(43) Pub. Date: May 2, 2002

(54) Method and apparatus for electronic trading

(76) Inventors: Sriketan Mahanti, Framingham, MA (US); Gaurav Mallik, Boston, MA (US); Kupuswamy Seshadhri, Chestnut Hill, MA (US); Arun Verma, Ithaca, NY (US)

Correspondence Address: Patent Group, Hutchins, Wheeler & Dittmar, 101 Federal Street, Boston, MA, 02110, US

(21) Appl. No.: 09/840,446

(22) Filed: Apr. 23, 2001

Related U.S. Application Data
(60) Provisional application No. 60/198,926, filed on Apr. 21, 2000.
(60) Provisional application No. 60/241,812, filed on Oct. 19, 2000.

(51) Int. Cl. G06F 17/60

(52) U.S. Cl. 705/37

(57) ABSTRACT

A system and method for performing automated negotiation processing in an electronic trading server are described. Users enter negotiation parameters and select one or more securities of interest for trading. An agent performs negotiations on behalf of the user in an automated fashion in accordance with the negotiation parameters. Users may monitor system information and the progress of their own agents through graphical displays of information and may modify the negotiation parameters during the negotiation process.

### REFERENCES TO RELATED APPLICATIONS

This application claims priority from U.S. provisional patent application No. 60/198,926 filed on Apr. 21, 2000, and U.S. provisional patent application No. 60/241,812 filed on Oct. 19, 2000.

### BACKGROUND

This application generally relates to computer systems, and more particularly to performing electronic trading.

Use of the computer system has expanded the way in which business may be conducted. One such area includes electronic trading, for example, as in performing electronic trading of bonds and other securities. Referring now to FIG. 1, shown is an example of a model of how electronic trading may be performed today, for example, for bonds with the assistance of a computer system. The model 10 includes a buyer 14 who may connect to a securities finder 16. The securities finder 16 may be a software program included on a server computer system that may obtain bond information 12 from a database including bond attributes, for example, such as bond yield, duration, credit rating, and the like. The bond information 12 may be used by a buyer in making an offer to purchase. The buyer 14 may be connected to the securities finder though an internet or other network connection to the computer system upon which the securities finder 16 executes. The securities finder 16 may locate a bond offered for sale in the trader database 18 in accordance with terms specified by the buyer 14. The trader database 18 may include static entries from traders 20a and 20b acting on behalf of investors or trading firms 22a-22d. This model is similar to the electronic trading currently in use, for example, by Limit Trader for Internet bond trading.

There are drawbacks with the foregoing trading technique. One drawback is that static matching is performed of offers to sell and offers to purchase. In other words, a static matching of attributes for buyers and sellers is performed. For example, offers are predetermined and once posted, they cannot be modified. Buyers and sellers either accept or reject offers. There is no automated negotiation process. Accordingly, deals may still be closed and further negotiated 429 elsewhere, such as through telephonic negotiations with traders or through traders interacting in “secure chat rooms”, such as Limitrader.com, rather than using automated electronic negotiating techniques.

Thus, it may be useful to provide a technique for electronic trading that provides for automated negotiation and dynamic matching of attributes.

### SUMMARY OF THE INVENTION:

In accordance with principles of the invention is a method executed in a computer system for performing an electronic transaction, and a computer program product for performing an electronic transaction. A plurality of user connects to an electronic trading system, each user being associated with a unique negotiation agent. Each of the plurality of users enters at least one negotiation parameter. Each of the plurality of users selects at least one item in connection with the electronic transaction. The plurality of agents automatically negotiates on behalf of the plurality of users for the at least one item. Each of the plurality of agents automatically determines subsequent values for at least one negotiation parameter.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example of a representation of prior art electronic trading;

FIG. 2 is an example of an embodiment of a computer system that may be used in performing electronic trading;

FIG. 3 is a flowchart of method steps one embodiment for performing an electronic trade;

FIG. 4 is an example of an embodiment of the electronic trading server of the system of FIG. 2;

FIG. 5 is a flowchart of method steps of an embodiment for an electronic transaction as may be performed by the Electronic Trading Server (ETS) of FIG. 2;

FIG. 6 is an example of modules that may be included in an embodiment of the Application Server;

FIG. 7 is an example of interactions between the Application Server and the Negotiation Engine;

FIG. 8 is an example of different modules that may be included in an embodiment of the Web Server;

FIG. 9 is an example of an embodiment of the Application Server;

FIG. 10 is an example of an embodiment of the network architecture of an embodiment of the system of FIG. 2;

FIGS. 11-17 are examples of screenshots that may be used in connection with displaying and obtaining negotiation parameter and user input;

FIG. 18 is a flowchart of steps of an embodiment of the negotiation process;

FIG. 19 is an example of varying levels of functionalities that may be included in an embodiment in connection with the negotiation process;

FIG. 20 is an example of a representation of a transition diagram of the different states of the negotiation process in an embodiment;

FIG. 21 is a flowchart of steps of one embodiment in connection with formulating counteroffers;

FIG. 22 is an example of a table summarizing the different possibilities using the different indices in forming a counteroffer; and

FIGS. 23-25 are examples of class diagrams of data used in the electronic trading system.

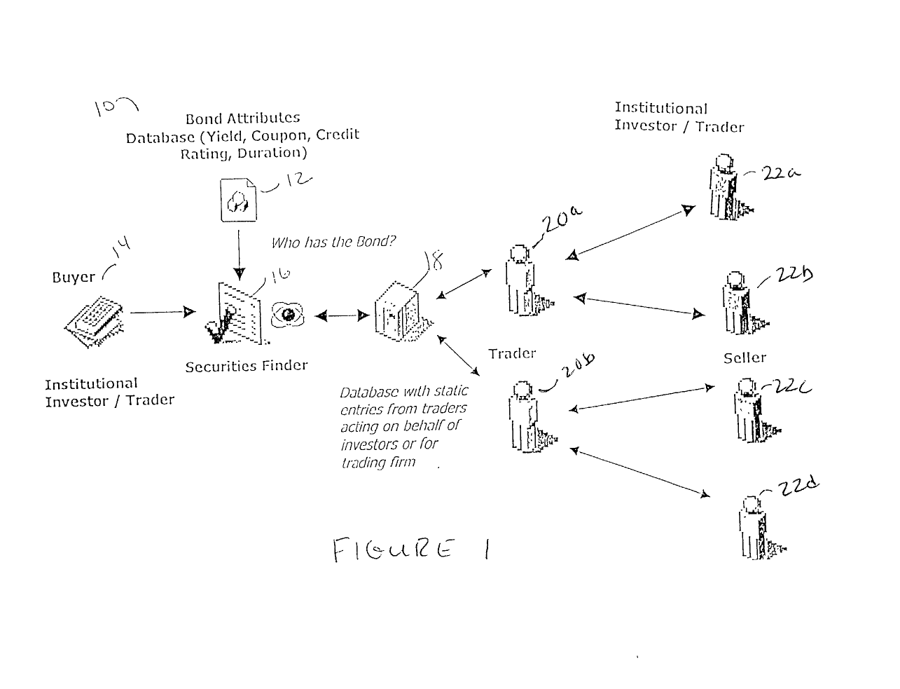

### DETAILED DESCRIPTION OF PREFERRED EMBODIMENT

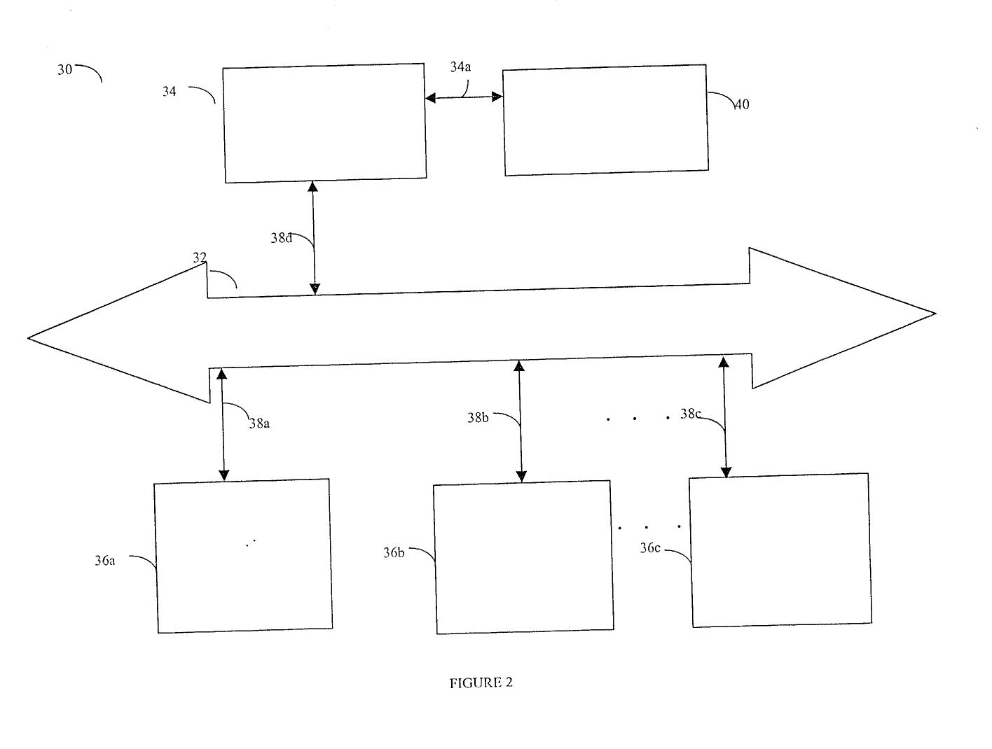

Referring now to FIG. 2, shown is an example of an embodiment of a computer system. The computer system 30 includes a first server system 34 connected to a network 32 by network connection 38d. Also included in this embodiment of a computer system 30 or in client systems 36a, 36b, and 36c connected to the network 32 respectively by network connections 38a, 38b, and 38c. Shown connected to the first server system 34 is an Electronic Trading Server (ETS) 40.

As will be described in paragraphs that follow in more detail, the first server 34 may be, for example, a Trading Server, such as an Alternative Trading System (ATS) or Electronic Communication Network (ECN). The first server system 34 may be used for examining various attributes about electronic securities, such as bonds, to be bought and sold by a user connected, for example, through the network 32 from a client system such as 36a. The first server system 34 is connected via connection 34a to an ETS 40. The ETS 40 may be used to perform, for example, trading on behalf of a client system such as 36a-36c. As will be described in more paragraphs that follow, the ETS 40 may be used, for example, to facilitate dynamic pricing of bonds through the use of agent-assisted automated multilateral negotiations. Similar to the traditional negotiations which happen over the phone, agents may act on behalf of a buyer or seller, such as someone connected through a client system 36a-36c, to negotiate on behalf of the client system.

Generally, the hardware and/or software included in the ETS 40 allows a buyer or seller to define the negotiation constraints, negotiation strategies and other market inputs that an agent negotiating on behalf of a buyer or seller needs to consider during the process of negotiation. The agents that will be described in more detail as executing in the ETS 40 dynamically mediate online transactions with other agents. Also, as will be described, the buying and selling and the negotiation process that occurs in the ETS 40 may be performed in an anonymous setting.

Additionally, it should be noted that in a particular embodiment described herein, the network 32 may be the Internet. Other embodiments may include other kinds of non-network 100 and network connections such as an Internet, or any one of a variety of other network or communication connections known to those skilled in the art. The server system 34, each of the client systems 36a-36c, and the ETS 40 may include any one or more of a variety of computer processors. For example, in one embodiment, each of the client systems 36a, 36b, and 36c may be personal computers connected to the network 32 through a dial up modem using services provided, for example, by an Internet Service Provider (ISP). The network connections 38a, 38b and 38c may be any one of a variety of network connections as may be provided and supported in accordance with a type of network 32. The client systems 36a, 36b and 36c may be any one of a variety of commercially available personal computers such as an Intel-based processor. The server system 34 may be any one of a variety of commercially available processors able to support incoming traffic as described herein.

The ETS 40 may be any one of a variety of commercially available processors also able to support incoming traffic and transactions as will be described herein. Particular examples of hardware and software are described elsewhere herein.

It should be noted that the particulars of the hardware and software included in each of the systems in an embodiment of a computer system 30 may vary with each particular application, as well as the number and type of users in a system.

Each of the client systems such as 36a, 36b and 36c may be a trader system, for example, from Fidelity, or Leahman Brothers, connecting to the server system 34 to perform electronic trading, such as buying and selling of bonds. For example, a first buyer may be logged on to, or connected to, the server system 34 from a client system 36a using network 32. The client, for example, may be a trader from Fidelity or Shearson-Leaman. In this example, the server system 34 may be viewed as an existing ECN server through which a trader may view attributes about the various security, such as bonds, that they wish to trade.

In this embodiment, there may be three (3) general classes of users of the ETS 40. These include end users, such as traders or brokers, integrators, such as partners, and system administrators. End users may generally be described as those traders and brokers, for example, that want to perform electronic trading. A trader, for example, may first view information using the first Server 34 who then decides to negotiate a buy or sell of an electronic security through connection 34a using the ETS 40.

An integrator may be a business partner, for example, such as Instinet or Island, partnering with the maintainers of the electronic trading system, for example.

The integrator may synchronize data stored in the database, for example, included in the ETS 40. In another embodiment, there may be yet another computer system connected to the network 32. This additional system may be an integrator system that may have a direct network connection to the ETS 40 that is similar, for example, to the connection 38d. The integrator may download data that to be included in the ETS 40 enabling synchronization of data in the database of the ETS 40. This may be done, for example, using scripts and batch files that allow the update of the ETS database to be synchronized and run, for example, “off line” during non-peak hours or as a background process.

The third type of user is a system administrator, for example, that may monitor the system 30 using various types of monitoring software, such as may be available from a third party vendor.

It should be noted that other types of users may have access to the system as well as other embodiments. However, in this particular embodiment, these are three typical users that may have access to the ETS 40 to perform various functions in accordance with associated responsibilities and tasks.

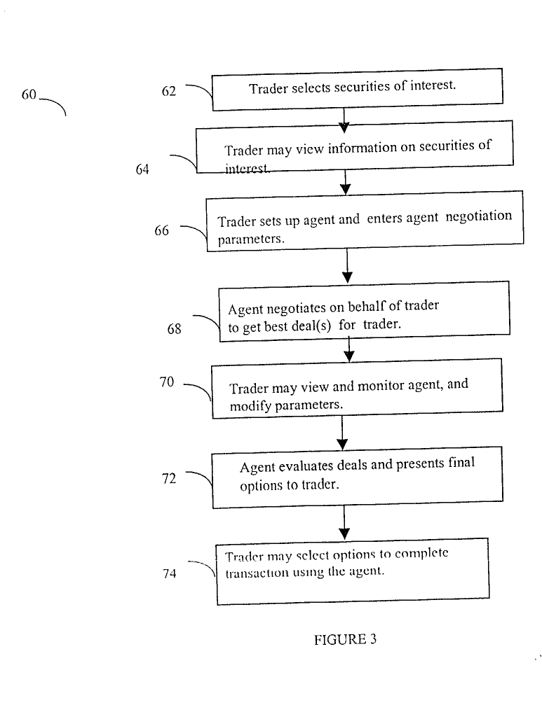

Referring now to FIG. 3, shown is a flowchart of method steps one embodiment outlining general steps for performing an electronic trade. The flowchart 60 includes some steps that may optionally be performed by a trader as described herein. These steps in flowchart 60 are those from the user perspective. At step 62, the trader selects the securities of interest. At step 64, the trader may view information on the securities of interest. Referring back to the computer system 30, a trader may be logged on to a client system 36a and access the first server 34 through the network 32. Using this connection to the System 34, the trader may view and select different information on securities of interest. Upon completion of these steps, the trader may decide to perform an electronic trading transaction. At this point, in connection with step 66, the trader may set up and initiate an agent and negotiation parameters by connecting via connection 34a to the ETS 40. This step will be described in more detail in paragraphs that follow. At step 68, the agent created and executing on the ETS 40 may be an automated process as will be described in more detail that negotiates on behalf of the trader to get the best deal for the trader in accordance with the negotiation parameters for the particular security desired. This may include, for example, buying and selling of a bond.

At step 70, the trader may optionally view and monitor the agent while performing step 68, for example, on behalf of the trader. Additionally, as part of processing of step 70, the user may also modify parameters, such as extend the time for a particular trade, change desired prices and/or quantities, and the like. Processing associated with step 70 may optionally be performed in an embodiment. For example, a portion or all of this functionality may be included in an embodiment in accordance with the various functions that need to be performed as well as the various type of monitoring capabilities an embodiment may decide to provide to a trader. At step 72, an agent evaluates the deals as a result of the negotiation process and presents the final options to the trader. At step 74, the trader may select the one or more options presented to complete the transaction. The agent may be used to complete the transaction for the trade, for example, in the buying and selling of the securities previously selected.

It should be noted that the particular functionality included in an embodiment in connection with viewing a trade and monitoring an agent as well as additional details regarding parameter values and user interfaces are described elsewhere herein in more detail in connection with screen shots or user interface displays.

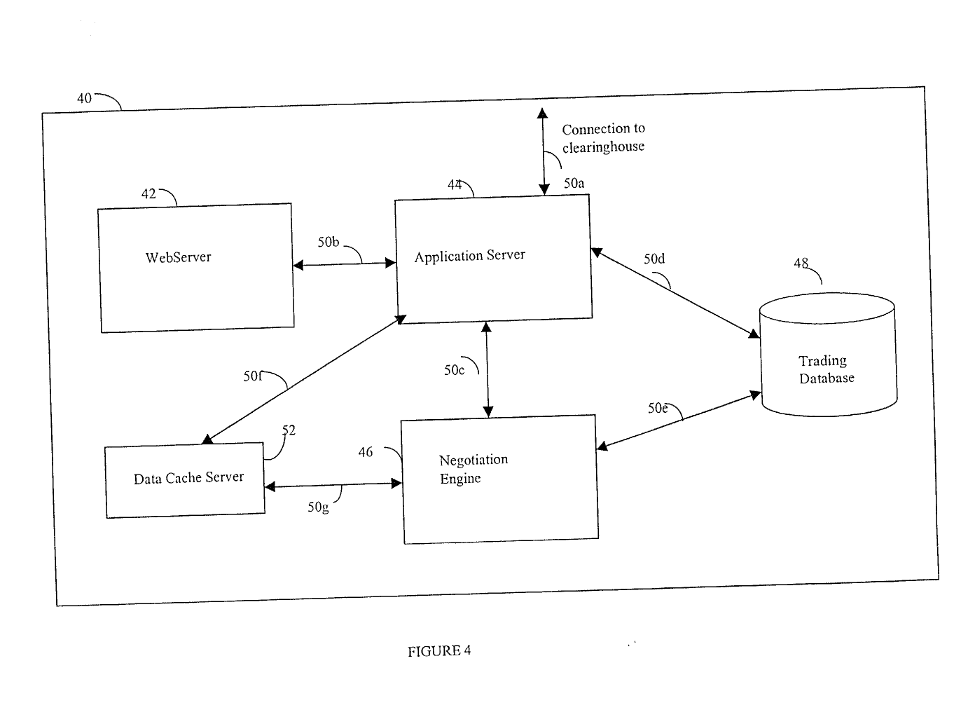

Referring now to FIG. 4, shown is an example of an embodiment of the ETS 40 as may be included in the system 30 of FIG. 2. Included in this embodiment of the ETS is a web server 42 connected to an application server 44. Also included in the ETS is a negotiation engine 46, a trading database 48 and a data cache server 52. In one embodiment, a user may connect, such as via a browser residing on one of the client systems 36a-36c to the server 34. When a user has selected a particular trade in accordance with static matching information as available through the server 34, the user may transfer control to perform the trade in the ETS 40. This may be done, for example, by a negotiate button as available in a software pull-down menu using a graphical user interface (GUI) of server 34. Using this technique, the user may connect to the web server 42 of the ETS 40 through server 34. In an alternate embodiment, there may be a direct connection between the browser such as executing on a client system 36a and the ETS 40. One technique for performing this direct connection between the client system 36a and the ETS 40 may be, for example, using a transparent login with a hyperlink connection to the Electronic Trading Server 40. A proxy may be used, for example, in allowing a user to access the ETS 40 from a remote system.

When a connection is made from the client system 36a to the ETS 40, the user may be prompted for additional information regarding the trade to be performed. In this particular embodiment, a user or client system 36a may be executing a browser served with one or more HTML pages. These HTML pages prompt the user to enter different negotiation parameters that are used in the process of performing the electronic trade. Additional details regarding this are described elsewhere herein in which these HTML pages, for example, may be served from the web werver 42. In this particular embodiment, the web server 42 processes the HTML information and extracts the content as entered by the user for various parameters that may be used in the negotiation process. The web server places this in an XML format in a structured page format in accordance with the XML mark-up language. It should be noted that other embodiments may perform data format and exchange information in accordance with other formats that may be included in that embodiment for performing communication between the different components of the ETS 40. For example, in one embodiment, this may include a web logic server or an Apache server. For example, an embodiment may use digital certificates and other varying security policies in accordance with standard practices and desired levels of security. These may vary in accordance with each embodiment. It should be noted that if there exists a proxy, security associated with user authentication may be performed within another third party system through which the user is connected to the ETS 40.

It should be noted in this particular embodiment that the web server 42 may be a separate computer system that may include one or more processors to perform the necessary service for those users connected by the Internet. Additionally, other embodiments may include more than one web server as well as other servers in accordance with the amount of traffic in the computer system 30. In other words, rather than have a single web server 42, there may be multiple web servers and a router may forward an incoming request to one of multiple web servers.

Information communicated between the web server and the application server may use an XSL engine that translates HTML into XML. Similar to the web server, the application server 44 may be a single computer system containing one or more processors. The application server 44 allocates or creates a thread for this particular user's session or negotiation session. In other words, there will be one thread created in the application server for each session for a particular user as may be connected from a client system such as 36a through a browser. The application server 44 also interacts with the trading database 48 to store information regarding the negotiation parameters. The application server may also store a copy of this in the data cache server for quick reference, for example, by the negotiation engine for future references by the application server.

Once the application server 44 has stored via connection 50d user preference information and other negotiation parameters in the trading database 48, the thread, user process and the like, as may vary with embodiment, is allocated and associated with this particular negotiation session for the user.

Other information may be included in the trading database 48, for example, if particular information regarding attributes about the different securities being traded. The database and a representation of information that may be included therein and used in the ETS 40 is described in more detail elsewhere herein.

It should be noted that the server 34 may be synchronized with information that may be stored in the trading database 58. For example, when a user on a Client system via a browser connects to the first server 34 to view information about various types of attributes of bonds, for example, this information may be synchronized with attributes stored in the trading database 48. Accordingly, there may be a connection, such as 50a, to a clearinghouse or other type of partnering organization which provides an update of the information to the trading database through the application server as well as a database of information that may be stored in the first server system 34. As known to those skilled in the art, any one of a variety of non-network and/or network connections similar to those described in conjunction with network 32 may be used to connect the trading database with a clearinghouse and used in connection with synchronizing the content of the trading database 48 with similar information that may also be stored in the server 34.

It should be noted that the application server 44 may be written in any one of a variety of commercially available language. In this particular embodiment, the application server may be written in Java and represent data in the form of objects. This is also described in more detail elsewhere herein and may vary in accordance with each embodiment.

Existing software may reside on a client system such as 36a-36c that provides for a connection to an existing system such as server 34 to view particular securities attributes. Software that executes on the client system 36a and is supported by the server system 34 may not provide for a connection between the client system 36a and the server 34 through the use of a browser executing on the client system 36a. In other words, there may be existing or older software executing on the client system 36a enabling a connection to the server system 34. Subsequently, if a user then wishes to connect to the ETS 40, the user will not be interacting with the ETS 40 through the use of a browser. The ETS 40 may include additional support to allow for connections to client systems with alternative techniques such as those in which the client does not use a browser to connect to the ETS 40.

An embodiment may include any one or more of a variety of techniques, such as using web pages with a web server and browser on a client system, collect information for various negotiation parameters. A user interface may also be provided by a particular server system 34 to gather information rather than use web pages and a browser on the client system. The user interface may vary with each particular existing server system such as 34, and the software on each client system. Accordingly, the client system, such as 36a, may provide a connection, for example, through server system 34 to the ETS 40 using RMI or Corba in the data transmissions between the application server 44 and the client system 36a.

In this alternative mode where a browser is not used on a client system such as 36a, the web server may maintain client “state” information and transmit data in the form of XML to the application server. In this instance, the web server does not serve web pages to the client system but rather transmits information in the form of a stream of data in accordance with the XML mark-up language format.

Data which is transmitted between any of the connections of the ETS 40 includes data transmitted between components in accordance with the XML format. An exception to this may be in the form of connections to the trading database 48 such as via connection 50d and 50e, in which data may be required to be written in a particular format, for example, in accordance with a format suitable for use with an Oracle database or other implementation of the Trading Database 48.

The application server 44 invokes the negotiation engine 46. A user session is a session associated with each user and instance thereof logged onto the ETS 50. In this embodiment, one thread or process may be created in the negotiation engine 46 for each item being purchased by a particular user associated with a particular session. A negotiation session may be a single session in which one or more users are connected via client 36a-36n to the ETS 40 for the purpose of negotiating in connection with a single security. In a single negotiation session, there may be three different transactions regarding different bonds or other securities that the client may wish to buy and sell. A single thread or process may exist in the application server 44 for this particular negotiation session. Three different threads or process exist in the negotiation engine 46, one for each of the different items or securities to be negotiated. Other embodiments may employ other implementation techniques and models in connection with negotiation of securities. A more detailed representation and description is included elsewhere herein.

During a negotiation process, the negotiation engine 46 may retrieve and store information from the trading database 48 through a connection 50e, and alternatively gather information from the data cache server 52 through connection 50g. As known to those skilled in the art, information may be stored in the data cache server 52 for purposes of speed in acquiring information that may be used, for example, by the negotiation engine and the application server. However, another embodiment may not include a data cache server. Another embodiment may include the data cache server but only have one connection to either the negotiation engine or the application server in accordance with the traffic and the types of securities being bought and sold in each implementation.

It should be noted that in a negotiation engine 46 may execute on a separate processor, similar to the application server or web server. Also similarly, the negotiation engine may execute on either a single or multi-processor machine. The data cache server 52 may also be a separate computer system with appropriate portions of cashing memory in accordance with each particular embodiment. The trading database 48 may also be stored on a separate computer system acting as a database server. It should be noted that other embodiments may include varying combinations of the foregoing servers in a single system in accordance with the amount of traffic in a particular embodiment as well as the availability of hardware.

The negotiation engine 46 may be written in any one or more of a variety of programming languages. In this particular embodiment, the negotiation engine is written in Matlab although any one or more of a variety of different programming languages may be used.

As previously described, the data transmitted within the ETS 40 between components, such as using connections 50b, 50f, 50c and 50g, may be transmitted in accordance with a particular formatted language standard, such as XML in this particular embodiment. Additionally, other types of data formats may be used to store information in the database such as the trading database of 48 using connections 50d and 50e. This data may be written in accordance with the data format expected by the different servers, such as the Oracle Database Server 48 in this particular embodiment. It should also be noted that data transmitted from the web server 42 to a client when the client uses a browser may be in the form of HTML pages in accordance with the HTTP communications protocol. Otherwise, for example, in an alternative embodiment the client system 36a may not use a browser and may be a mature existing system that uses a different type of interface. In this instance, the client software in the client system 36a may be in accordance with RMI (Remote Method Invocation) or Corba (Common Object Request Broker Architecture) or other messaging Application Programming Interface (API) rather than the HTML standard. It should also be noted that a user may connect to the ETS 40 and utilize modules in accordance with the HTTP standard and also use modules in accordance with RMI or Corba. In other words, a single user may utilize functionality associated with two different protocols and/or in accordance with two or more different standards.

It should also be noted that a variety of different types of network protocols may be used in performing the communications between the different components of the ETS 40. For example, with the connections 50d and 50e, the TCP/IP protocol may be used as the communications protocol for data transmissions.

The foregoing embodiment of the ETS 40 may include any one of a variety of hardware and software combinations, for example, including different protocols as well as formatted language standard for data transmissions within the ETS as well as communications between the ETS 40 and the clearing house as well as a client system 36a. These different combinations of hardware and/or software that may be used may vary in accordance with each particular embodiment.

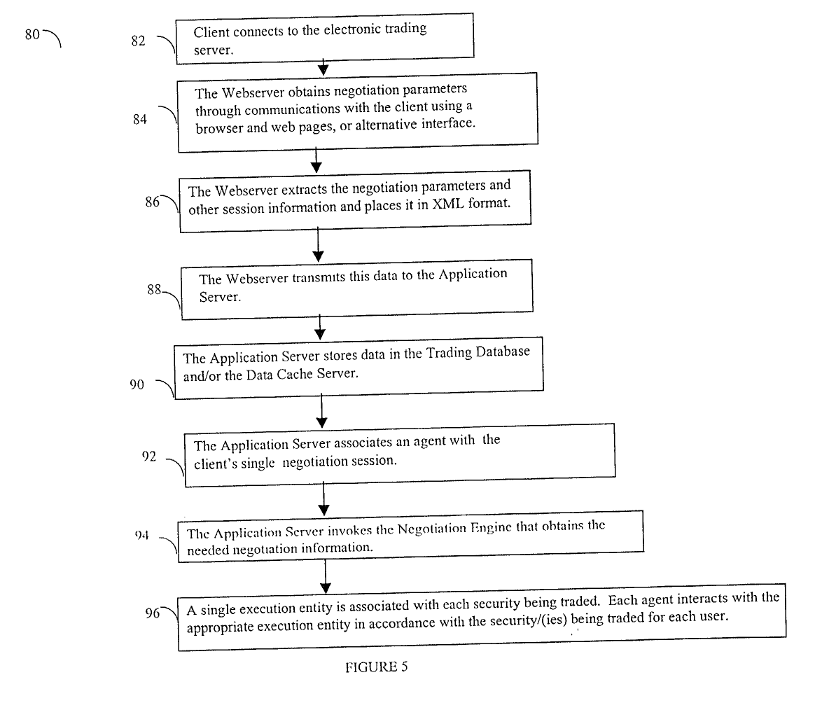

Referring now to FIG. 5, shown is a flowchart of method steps of one embodiment in connection with performing an electronic transaction. In this embodiment, the steps of flowchart 80 may be performed by components the ETS 40. Generally, the steps that will be described in connection with the flowchart 80 summarize the flow of information within the application server 40 just described. At step 80, a client connects to the ETS. As previously described, a client such as 36a-36c of FIG. 2, may connect either directly to the ETS 40 or through the use of legacy or existing system, such as a first Server 34.

At step 84, the web server obtains negotiation parameters through communications with the client using the browser and web pages or the alternative interface. As previously described, if the client system 36a uses a browser, web pages may be used to obtain negotiation parameters. Alternatively, if the client system 36a does not include a browser and the communications and existing software on the first server system 34 do not support a browser used on a client system 36a, an alternative interface may be used to gather information and negotiation parameters used by the ETS 40. This step is described in more detail in following paragraphs in connection with, for example, screen shots that may be included in an embodiment to obtain user input and negotiation parameters.

At step 86, the web server extracts a negotiation parameter and other session information and places in an XML standard format. The web server at step 88 then transmits this data to the application server 44. At step 90, the application server communicates with the trading database and/or the data cache server in accordance with each particular embodiment storing data as needed in performing the negotiation on behalf of the client system.

At step 92, the application server associates an agent with the client's single negotiation session. At step 94, the application server invokes a negotiation engine. The negotiation engine obtains the needed negotiation information through one of several connections, such as communicated directly from the application server through connection 50c, or negotiation engine may directly obtain the data it needs through the trading database 48 and/or the data cache server 52. At step 96, the negotiation engine associates one execution entity with each type of security or other item being traded. The user's agent communicates with each execution entity to negotiate on behalf of the particular trader for each items being traded. This is described in more detail elsewhere herein.

In one embodiment, the ETS 40 may use distributed objects and associated methods and protocols in connection therewith. As described elsewhere herein, one embodiment may include a webserver or other external communications server for interfacing with, for example, client systems and server 34. These communications may be in accordance with HTTP/HTTPs protocol. Alternatively, communications between the external server and another external system, may be in accordance with TCP/IP or other proprietary protocols, for example, when an external system does not support communications in accordance with the HTTP protocol, such as between a webserver and browser. Communications between the webserver and application server may be in accordance with the RMI and Internet Inter-ORB Protocol (IIOP), as may also be communications between the negotiation engine and the application server. Communications between the application server and the database, as well as the negotiation engine and the database may be in accordance with the TCP/IP protocol. As also described elsewhere herein, other embodiments may also employ protocols and standards that may vary with each embodiment.

An embodiment may include Java-based client and server software employing object oriented programming techniques and facilities. The client software in one embodiment may include use of Internet Explorer V4.0 or greater or Netscape Navigator V4.0 or greater and also use client-side Java Script and applets running under Java 1.0 or greater. The webserver in one embodiment may include a servlet engine and provide content in one or more of a variety of formats to a browser or other client software. The application server may encapsulate business objects and rules and support IIOP and other interfaces to enable communication with databases and the like. The database server, for example, may be an Oracle database that stores persistent information. An embodiment may also include database optimization, as known to those skilled in the art, such as using techniques of duplication, views, replication and procedural code as may vary in accordance with each implementation. Various aspects of one embodiment may include runtime architecture characteristics. Use of servlets may enable dynamic content for client systems.

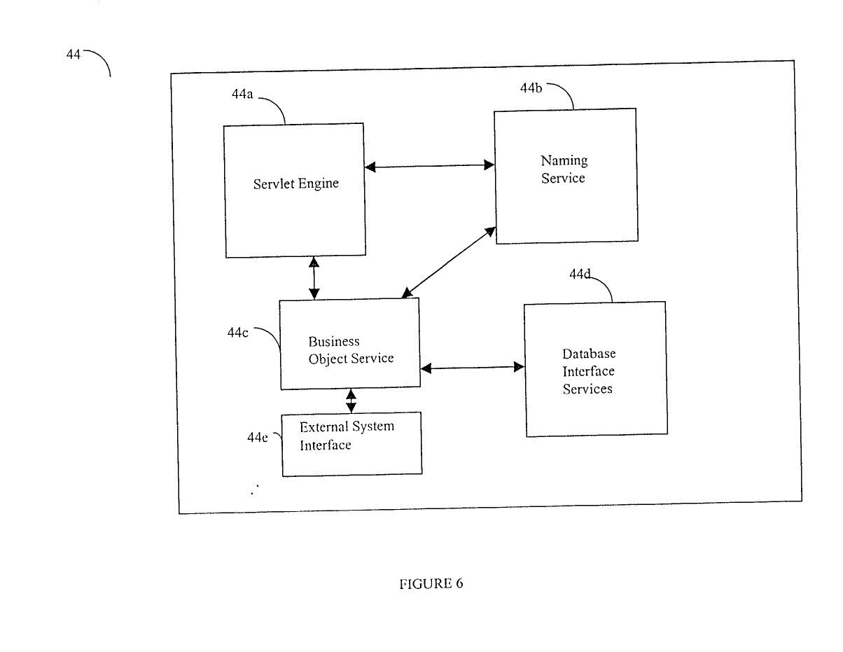

Referring now to FIG. 6, shown is an example of one embodiment of modules that may be included in the Application Server 44 previously described connection with FIG. 4. It should be noted that other embodiments may include the modules of FIG. 6 as well as additional modules that may vary in accordance with each embodiment. The Servlet Engine 44a may interface with the Web Server 42, using connection 50b previously described in connection with ETS 40. The Naming Service 44b may be a standard Naming Service as known to the scope in the art for example used in naming objects by the Business Object Service 44c. Generally, the Naming Service 44b provides an automated mechanism for naming objects in the form of a hierarchy and may be used, for example, in connection with object oriented class libraries or other types of hierarchical arrangements representing objects that may be stored in the database.

Business Object Services 44c manages objects that are created and used in the ETS 40. For example, there may be a plurality of objects used when a user logs on to the server the ETS 40. An object may be allocated from a pool of previously created objects that are managed by the Business Object Service 44c. When the object is no longer needed within the ETS 40, the object may returned to a pool of objects available for other users in connection with other sessions. The Business Object Service 44c manages creation and the use of various objects. For example, the negotiation profile or parameters associated with a session as described in more detail herein may be a business object or a one type of a business object that may be used to store information and represented in the ETS database 48. The Business Object Service module 44c may interface with the database interface services module 44d to perform any necessary data conversions for a particular database that may be used for example in implementation embodiment of the trading database 48. As shown in FIG. 6, the different modules such as 44a and 44c interface and interact with each other as needed in connection with performing various functions as performed by the Application Server 44.

It should be noted that an External System Interface 44e may be used in facilitating connection with external systems, such as through connection 50a.

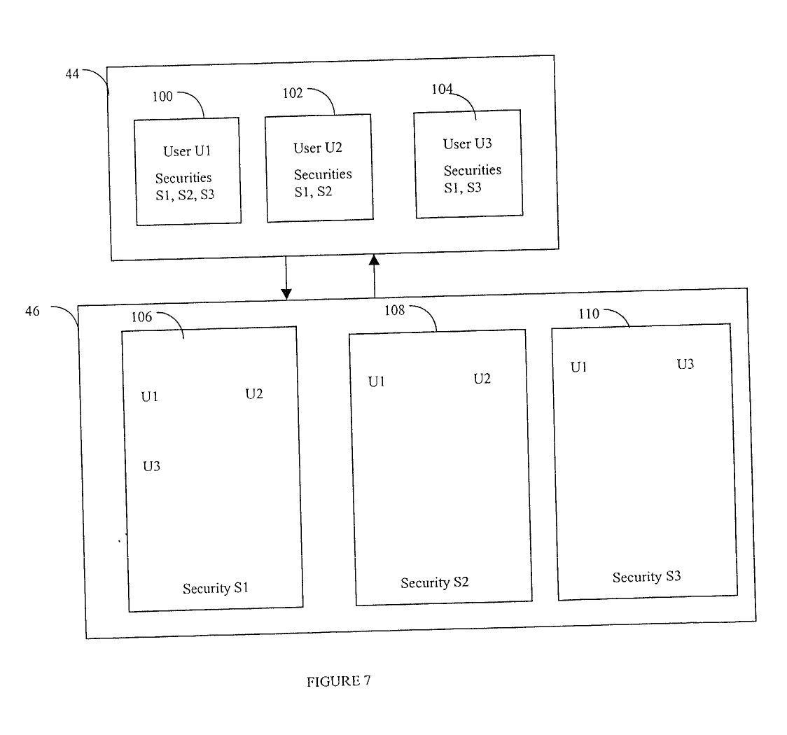

Referring now to FIG. 7, shown is an example of one embodiment of the interactions between the Negotiation Engine and Application Server in connection with performing negotiations on behalf of one or more users in the ETS 40. Shown in FIG. 82 is a snap shot of the ETS at a particular point in time at which three (3) users, user U1 100, user U2 102, user U3 104--are negotiating in connection with particular securities. As described elsewhere herein, the Application Server 44 is responsible for the creation and management of the objects within the system. An object in this example is associated with each particular user or session when a user logs on to the ETS system 40. The snap shot illustrated in FIG. 7 is the snap shot of the system in which there are three users currently in the system. This may vary at different points in time of the system at which a particular snapshot may be taken.

Also shown in FIG. 7 are the various securities in which each of the different users are interested. In this example, user U1 100 is interested in securities noted as S1, S2, S3. User U2 102 is interested in buying and/or selling securities S1, and S2. User U3 104 is interested in buying and /or selling securities S1, and S3. An object may be allocated from a pool or created in accordance with a particular embodiment and associated with a particular user within the system. For each user, when all user information, such as regarding the types of securities and negotiation parameters, are input, the object corresponding to a particular user 100, 102 and 104, for example, may be allocated from a pool of objects and associated with a particular user's session.

In one embodiment, trading information may be “pushed” from the Application Server 44 to the Negotiation Engine 46 as associated with each user. In accordance with the different techniques that may be used in each particular embodiment, a remote procedure call, for example, may be used if each of the Application Server and the Negotiation Engine are executing on different processors or systems.

In another embodiment, the Application Server and the Negotiation Engine may reside on a single processor in which a regular procedure call, for example, may be used to communicate information between the Application Server and the Negotiation Engine. Other communication techniques may also be used as known to those skilled in the art to perform communications between different components of the ETS 40 in accordance with the different hardware and software configurations in each particular embodiment.

In this example, the information may be pushed from the Application Server to the Negotiation Engine. The Application Server may initiate the data transfer by sending different negotiation parameters as well as the different types of securities associated with the particular user. Negotiation Engine 46 may have a pool of existing threads or processes having a one-to-one correspondence with a particular security supported by the ETS 40. This thread or process becomes active when a particular user is interested in buying and/or selling securities of that particular type.

In this particular example, users U1, U2 and U3 are interested in trading securities S1, S2, and S3. Thus, as illustrated in FIG. 7, those processes corresponding to securities S1, S2, S3 respectively numbered 106, 108, and 110, are active in performing negotiations in accordance with parameters for the users 100, 102, and 104.

In one embodiment, each of the security elements such as 106 associated with a particular security may be implemented as a process. Other embodiments may implement each of the security elements 106, 108, for example, as threads if there is a multi-threaded environment or a multi processor system. The different types of implementation detail, such whether a security element 106 is represented as a process or thread, may vary in accordance with each particular embodiment. Generally, each of the elements 106, 108, 110 executes a negotiation process for each of the users in terms of their different profile information, such as pricing and whether they are buying and selling securities of that type.

In this example, each execution entity, such as 106, associated with a particular security performs negotiations between the users U1, U2, and U3 in an attempt to maximize and satisfy the order or orders for each user. Each of the securities has an associated execution entity that may execute independent of other execution entities. Additionally, the number of users as depicted as being associated with the negotiation process of a particular security such as with the element 106 varies each time within the system and is dynamic. Similarly, the number of users within the system as may be represented by different objects 100, 102, and 104 in the Application Server are dynamic in number and may vary in accordance with the number of the users on a particular ETS 40 at any particular time.

Described elsewhere are more detailed processing steps executed by each of the negotiation agents as represented by the element 106, 108, and 110. Generally, each of these elements correspond to a security agent that performs negotiations on behalf of each of the users.

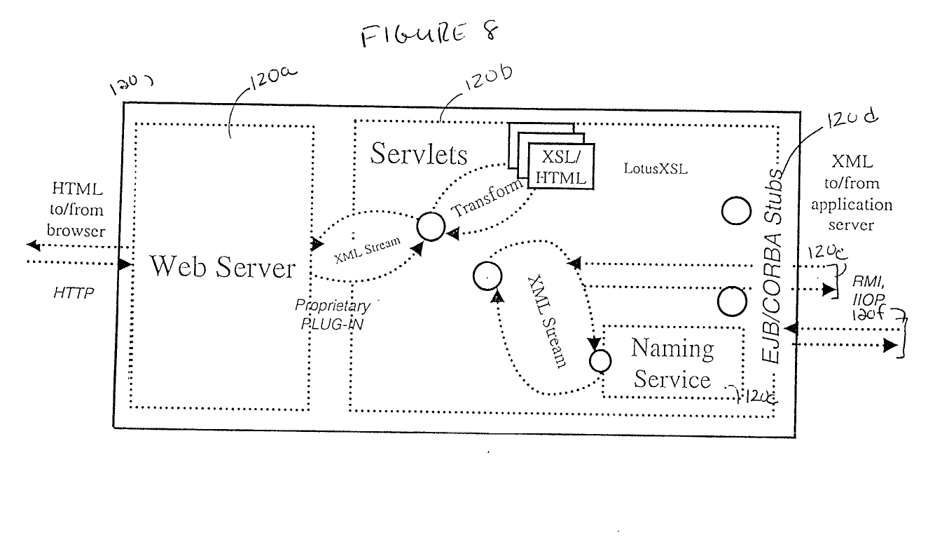

Referring now to FIG. 8, shown is an example of one embodiment 120 of the different components of the Web Server and/or the Application Server. It should be noted that an embodiment may include a portion of those modules described in connection with 120 in solely the Web Server, or also include a portion of the modules in the Web Server and a remaining portion in the Application Server, as will described herein. Illustrated in 120 of FIG. 8 is the Web Server 120a interfacing with a portion of functionality that may also be included in the Application Server 120b. In this example, HTTP is the protocol that may be used, for example, to interface between the Web Server and the user. The Web Server 120a may transfer information between the Web Server and the Application Server, for example, in the form of an XML stream using a proprietary plug in and/or using a standard XSL engine. Different servlets may be used for each particular user in the system for a session. Data may be transformed from the XML stream into any one or more of a variety of different types of formats such as Lotus XSL in accordance with the different components within the Application Server. Also shown in FIG. 8, the XML stream data may be used as input to the Naming Service 120c, for example, in connection with creating and naming different types of objects in one embodiment. EJB/CORBA stubs may be also used, for example, when performing and transmitting data between the Application Server and different data bases or other servers.

Connection 120e shows one set of connections that may be used in transmitting XML format data to/from other components of the Application Server, for example, in another system or other type of processor. The RMI/IIOP connection 120f, for example, may be used to send data in accordance with another type of format to another destination. In other words, the Application Server may have more than one type of data connection and perform more than one type of data transformation in accordance with the one or more systems and their different attributes as needed to protect your embodiment. Although, two different types of connections 120e and 120f are shown in FIG. 8, an embodiment may include one or more in accordance with the needs of each system.

In one embodiment, the Naming Service 120c may be implemented, for example, as a Web Logic service. In one embodiment, referring to FIG. 4, the Web Server 42, the Application Server 44 and the data cache server 52 may be written in accordance with the J2EE standard which is a standard as known to those skilled in the art for the Java application design. An embodiment using the J2EE standard may include a Naming Service implemented as a Web Logic Naming Service. The Negotiation Engine 46 in this particular embodiment may include code that is written in Matlab, for example, as described elsewhere herein which each of the agents correspond to a Matlab process. It should be noted that other embodiments may be in accordance other standards and includes software written in other programming languages. Additionally, other embodiments may have different hardware and software configurations. The particulars of implementations and variations in hardware and software should not be construed as a limitation of the principles described herein.

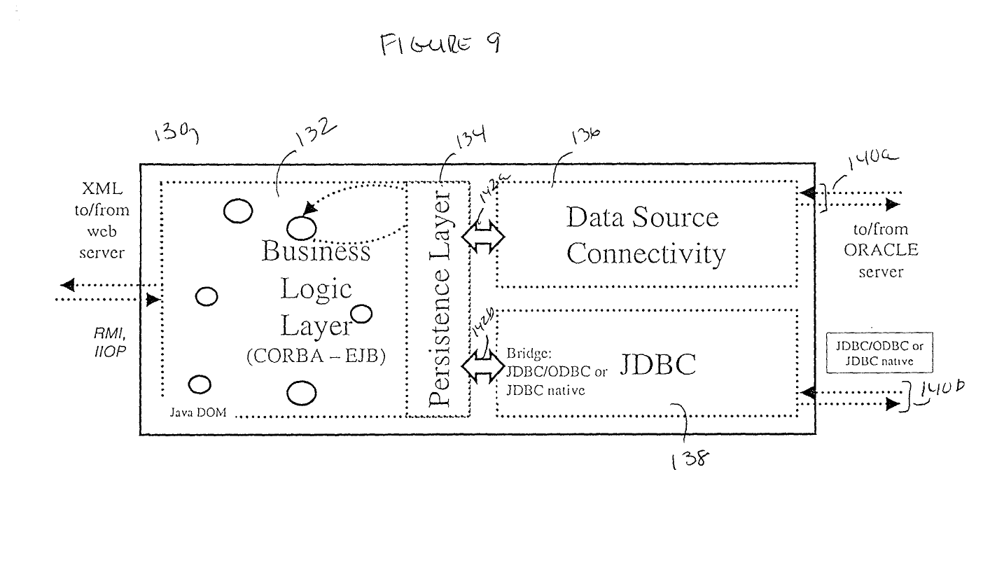

Referring an other FIG. 9, shown is a more detailed example of an embodiment of an Application Server. Recall that the Application Server is also described in connection with FIG. 4 as element 44. Shown in FIG. 9 is a representation of more detailed components that may be included in an embodiment of the Application Server. In representation 130, the creation and management of objects . may be handled by the Business Logic Layer 132 and may be written, for example, in accordance with CORBA-EJB standards. The persistence layer 134 may be used to interface through different connections such as 142a and 142b to other components that may be included in the Application Server.

A first connection 142a may be used to connect to the Data Source Connectivity 136 with the Business Logic Layer 132. The Data Source Connectivity 136, for example, may include code that perform transformations of data which is transmitted to an Oracle server 140a. The trading database of the ETS may be implemented as an Oracle server. In other words, the data source connectivity 136 may perform data transformations that place the data in a form that is acceptable by the Oracle server.

In this example also the Application Server 130 includes another connection to another processor or system. JDBC or ODBC may be used as the second interface 138 that performs other types of data transformations transmitting data through connection with 140b in accordance with the data form acceptable by the receiving system.

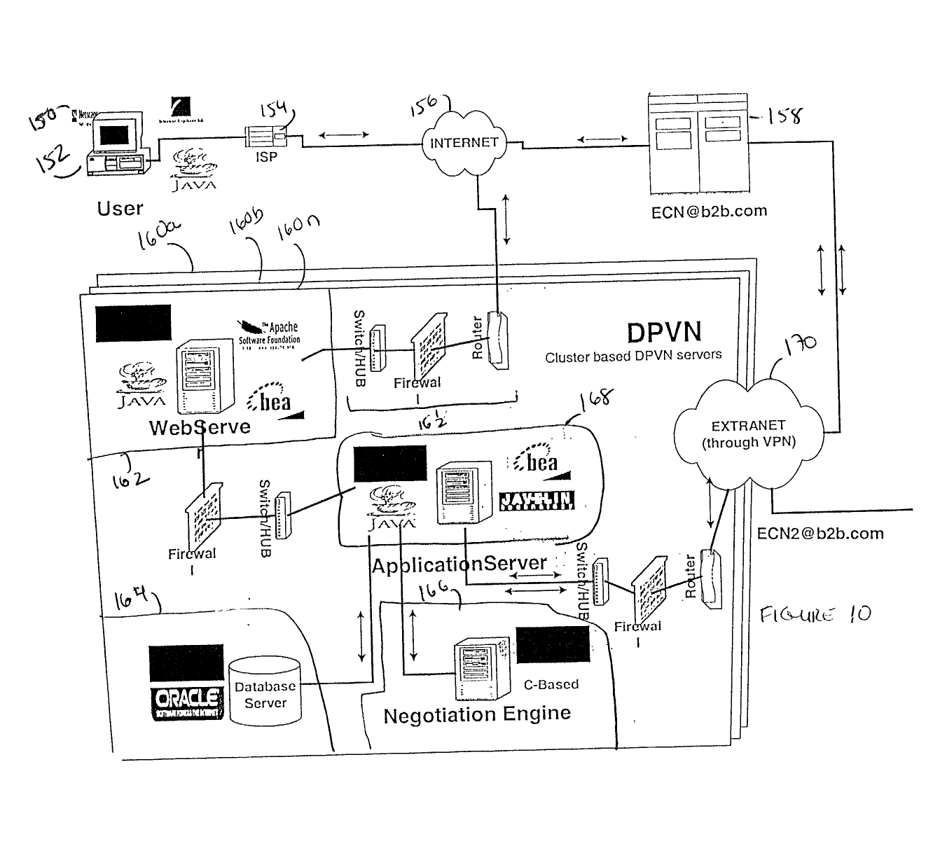

Referring now to FIG. 10, show is an example of an embodiment of the network architecture of an embodiment of the system 30 represented in FIG. 2. In the illustration 150 of FIG. 10, a user 152 may connect to one of the ETS 160a to 160n through the Internet 156. In this example, the user 152 receives services through an Internet connection by an Internet service provider (ISP) 154. The user 152 may use another system 158 in selecting the different types of characteristics and parameters about particular securities of interest. Subsequently, the user 152 may connect either directly to one of the servers 160-160n or through the system 158 to one of the servers 160-160n.

Collectively, the servers 160-160n are a cluster based formation of servers in this example representing the system or ETS 40. In other words, in this embodiment the system ETS 40 which performs negotiations on behalf of the user or users is implemented using distributed techniques having a plurality of servers. Additionally, within each of the servers such as 160a to 160n, different components previously described in connection with FIG. 4 exist on different systems that may be networked together. In this example, user 152 may connect to an instance of a DPVN server through a router with a firewall and a switch hub represented as element 162. The user may connect to server 160n which has a Web Server 162 on the first system. Connecting to another fire wall and switch hub, the user subsequently has operations performed on his or her behalf by the Application Server 168. The Application Server 168 and Web Server 162 may be written in Java.The Negotiation Engine may be written in C and implemented as a multi threaded software application. The database server may use products by Oracle, such as commercially available Oracle database packages.

Each of the different servers, such as the Web Server, the Application Server, the Negotiation Engine, and the database server may be on separate systems or processors t connected to a network, such as using the Internet or other type of private network connection. In this embodiment, a firewall is used with the switching hub to ensure communications are secure between each and different components of the system. Additionally, each of the servers 160a-160n may be connected to one or more other systems for examples to virtual private network (VPN) 170. The extranet virtual private network connection 170 may be used to download particular dynamic data about different commodities and/or securities of interest.

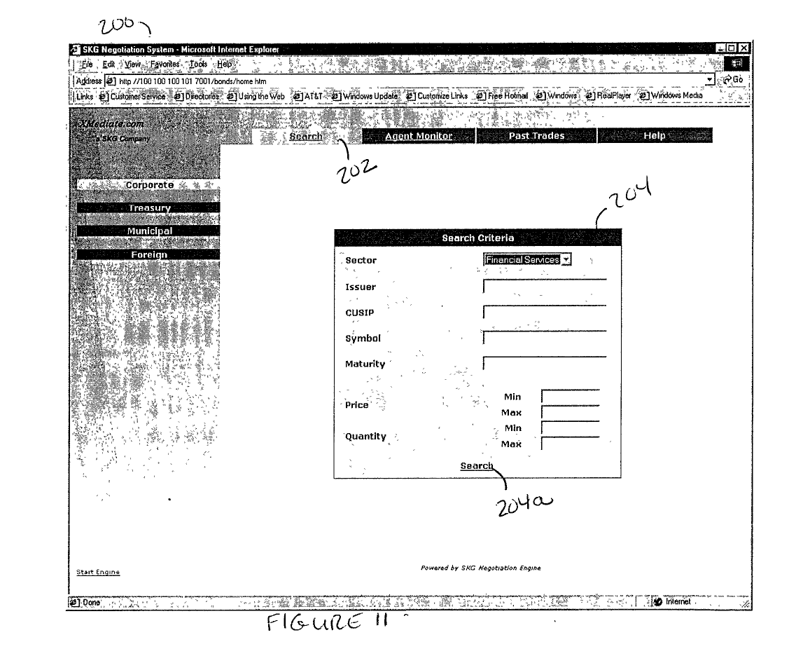

What will now be described in connection with FIGS. 11 through 17 are examples of screen shots or user interface displays as may be included in an embodiment of the ETS 40 described elsewhere herein.

Referring now to FIG. 11, shown is an example of a user interface 200 as may be displayed in connection when performing a search option for a particular security. It should be noted that although, as described herein, a security of interest that may be selected, for example, may be a bond, the principles included herein may be generally applied for use in negotiations regarding any type of security. Further, the principles and techniques described herein may also be used in connection with any type of negotiation in general.

The user interface 200 includes a variety of different options, buttons and user feedback panels. The search button 202 may be activated and brings up a dialog box 204 where a user may enter particular search criteria. Generally, in one embodiment, the screen shot 200 may be displayed in connection with obtaining particular search criteria, for example, when a user is investigating or searching for particular securities within the ETS 40. In this example, the dialog box 204 provides different locations within which the user may enter different types of parameters or information in order that a query or a search may be performed to retrieve different types of security or securities in accordance with the entered criteria.

As included in the dialog box 204, different types of information may include, for example, the type of issuer, the CUSIP which refers to a unique identifier associated with a particular security, a symbol associated with a particular security, as well as price and quantity information. Once the particular criteria has been entered in the dialog box 204, a user may invoke a search by selecting button 204a for example, as with a mouse or other type of selection device.

It should also be noted that a different system may be used to search or retrieve different types of information in accordance with a particular price and quantity. In other words, other conventional systems may be used to query and perform investigative searches with regard to different security interests in accordance with different criteria. In this example embodiment, this functionality may be included, for example, in the application server.

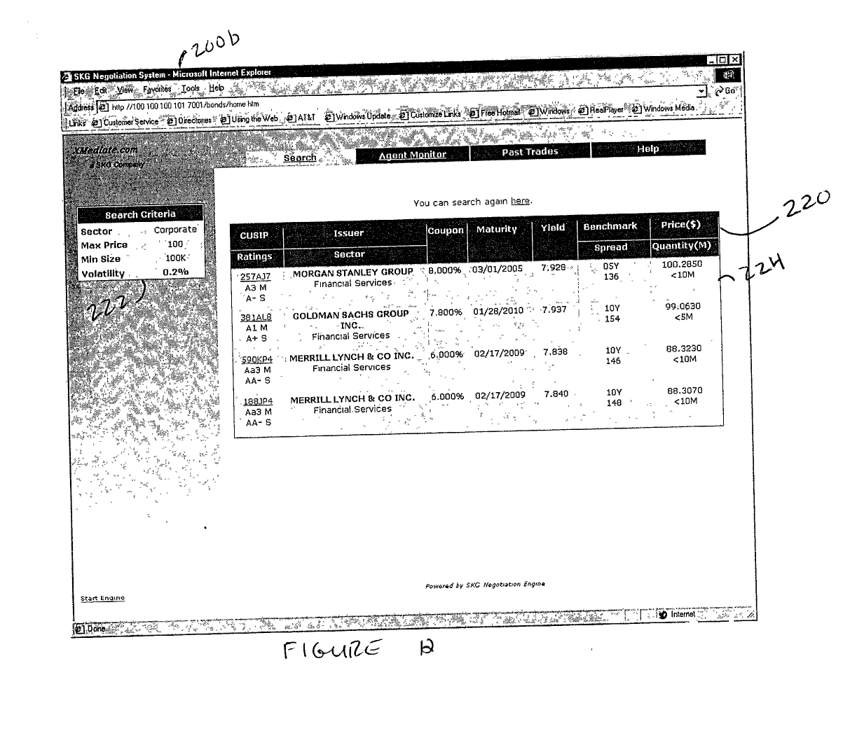

Referring now to FIG. 12, once the search results have been obtained in accordance with criteria entered, for example, in dialog box 204, the screen shot 200b may be displayed to a user.

Referring now to FIG. 12, shown is a screen shot 200b which may be displayed in connection with previously entered criteria in accordance with a particular user query for securities. Displayed in this example are a summary of search criteria in box 222, a summary of the information or types of security retrieved in accordance with the search criteria 220. It should also be noted that in this example, Microsoft Internet Explorer is the browser, for example, that may be used to display the particular user interface or screen shots 200b and 200 as also described in connection with FIG. 11. As displayed in screen shot 200b search criteria box 222 indicates that the user previously had entered a maximum price of 100, and a minimum size of 100 K. Additional criteria such as volatility may be used in performing a query. In this example, parameters such as volatility may relate to the ups and downs experienced in accordance with past performance in other activities of a particular security.

It should be noted that an embodiment may include these and/or other types of search criteria. In accordance with the search criteria displayed in box 222, the ETS 40 has retrieved and identified four particular securities of interest as displayed in chart 220. It should be noted that in an embodiment such as this, information may be stored in the trading database 48 and forwarded out through the Web Server 42 to the user and displayed in screen shot 200b. Additionally, rather than store the information within the trading database 48 as described in connection with FIG. 4, an external connection may be used directly connected to a component of the ETS 40 such as the trading database or other functional component which further forwards data on the different types of securities of interest.

In this example, the information displayed is current or dynamic information. Thus, the trading database 48, for example, if used to store and retrieve information from, would need to have some type of an update of the data stored therein such as via connection 50a to a clearing house as also described in connection with FIG. 4.

In screen shots that follow in this example, security of interest is a bond selection 224 as included in screen shot 200b.

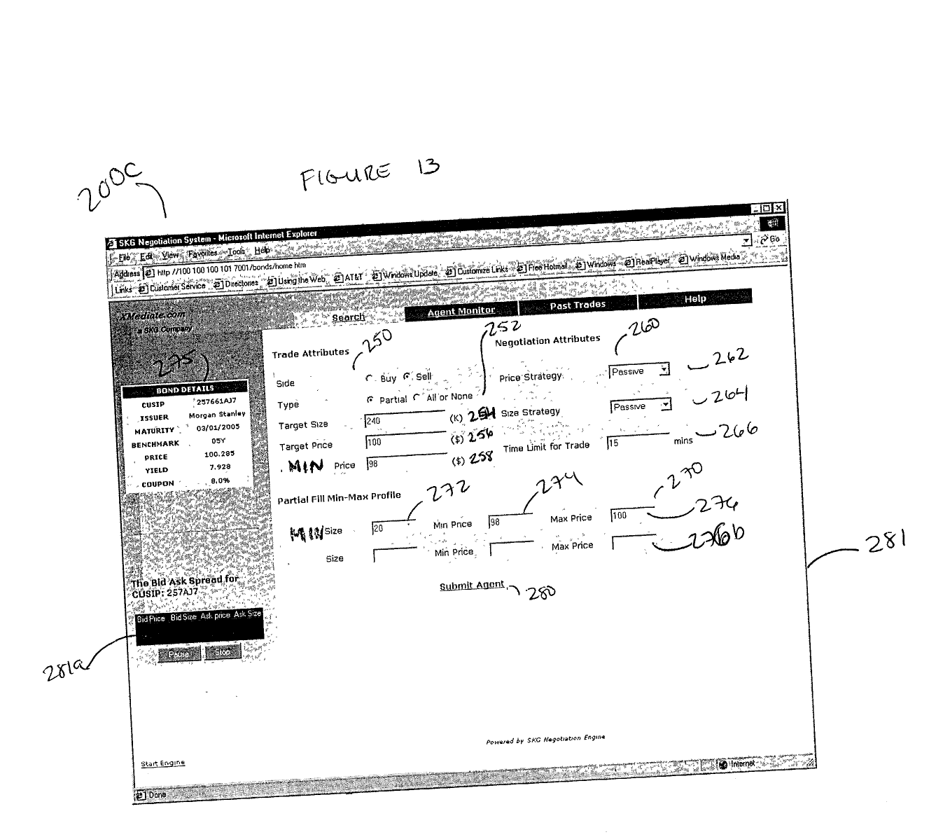

Referring now to FIG. 13, shown is a screen shot 200c which provides an interface for obtaining user input parameters in accordance with the agent setup. In other words, the user enters particular criteria or negotiation parameters which may cause an agent of the application server 44 to negotiate with a negotiation engine 46 on behalf of this particular user in accordance with the criteria entered. In the previous screen shot of FIG. 12, the user has selected the Morgan Stanley Group bond indicated as table entry No. 224. The bond selected in screen shot 13 via entry 224 has information subsequently displayed in tabular form 275 in screen shot 200c of FIG. 13.

The right hand portion of the screen shot 200c which is identified as 281 includes negotiation parameter attributes. Generally, this may be used in providing initial conditions and parameters which the negotiation engine may use in performing negotiations on behalf of a user. In this example, these parameters include trade attributes 250, negotiation parameters 260, and partial fill min-max profile information 270. It should be noted that in this example the attributes in the entry 270 are used as attributes conditional upon the selection of the type of trade being a partial fill order as indicated in field 252.

The trade attributes 250 indicate whether a particular user wishes to buy or sell a particular bond or other security, the particular type of order, such as whether the user is willing to accept a partial fill of their order or whether they are simply going to accept only those which meet their total target price and size as indicated, and pricing information.

The negotiation attributes 260 are generally those which effect the negotiation process itself as well as, for example, formulating counteroffers and when to terminate trading altogether. In this example, a price strategy may be indicated in field 260 by selecting from a menu. Price strategy may include, for example, passive, moderate or aggressive. Similarly, with sizing strategies as indicated in field 264, the strategy may also be one of passive, moderate and aggressive. The negotiation agent uses these parameters, for example, in formulating a counteroffer in accordance with the time limit that may be indicated in field 266. An embodiment may also include other negotiation attributes, for example, such as a delivery date which may also affect different strategies and whether a user, for example, is willing to accept an earlier or later delivery date.

The table 270 includes a specification of different parameters that are used in filling a partial fill of an order. In particular, table 270 includes a row 276 of several different data points including min size 272, min price 274 and max price 276. Generally, as will be shown in paragraphs that follow and in connection with other figures, these parameters may be used to indicate within what boundaries an order may be filled if being able to partially fulfill an order rather than all or none is acceptable. In other words, in this example the user has indicated that optimally they desire to have a target size of 240 K at a target price of 100. However, since a partial fill is acceptable, they are willing to accept at a minimum for a collective size for one or more orders for a single round of offers with a size of 20, at a minimum price of 98, and a maximum price of 100.

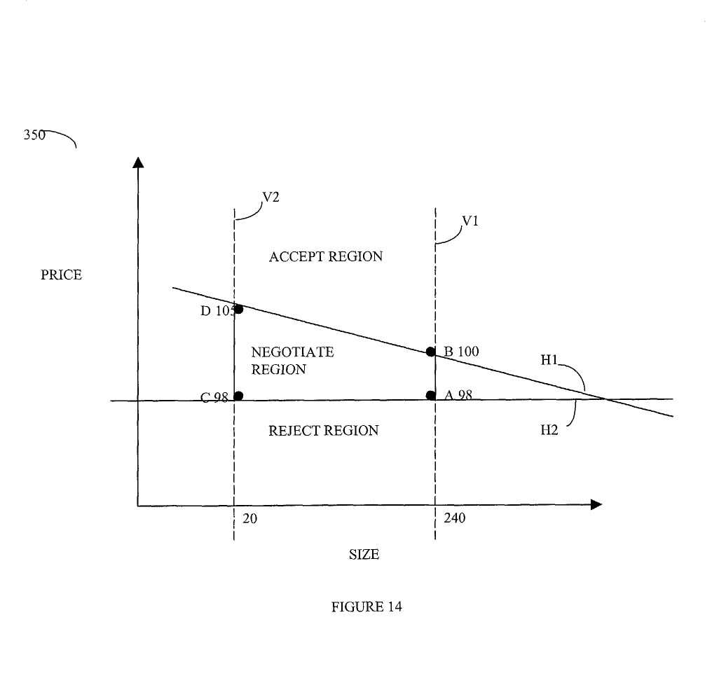

It should be noted that as described in connection with FIG. 14, the trapezoidal shape shifts to the left in connection with partial-fill orders as a transaction is partially filled in connection with each round as the remaining quantity to be fulfilled decreases.

What will now be described is an example of a partial fill order that may be fulfilled with completing several different trades or transactions. A user decides to sell a quantity of 240 K. There are multiple buyers to whom, collectively, the whole quantity 240 may be sold in connection with multiple orders. The minimum size of 20 K indicates that no less than 20 K is to be sold in a single order.

Included in the lower left comer of screen shot 200c is field 281a which produces dynamic feedback or display information in accordance with the dynamic snapshot of the system. Currently, for system being monitored, there is no snapshot regarding the bid/ask spread for this particular bond being of interest to the user. However, if there are ongoing negotiations for this or those in accordance, for example, with the system to date based on information for negotiations taking place to this point in time in the system, the field 281a may display certain information such as bid price bid size, ask price and ask size in accordance with different types of deals that have occurred in transactions as performed by the ETS 40 in the system. This will be described in more detail in paragraphs that follow.

Other types of information may also be listed as well dynamic information feedback as may be displayed, for example, in entry 281a of screen shot 200c. The information displayed, for example, in field 281a may be used by a buyer or seller to determine market conditions and may be used in formulating different parameters such as price as may be entered in field 256 of screen shot 200c.

As will be described in paragraphs that follow, graphical displays may be used in connection with illustrating the bounds within which a customer's agent may negotiate on his behalf to fulfill an order, in particular, a partial order. In connection with partial fill orders, a two-dimensional shape may be formed in accordance with the partial fill min/max profile information entered at line 276 and also the target size price and min price. Additionally, other data points may be used in curve fitting as will be described in paragraphs that follow and may entered, for example, in table entry 276b, included in table 270.

Generally, a partial fill order and what is acceptable in terms of a negotiation parameter may be represented by a two-dimensional shape. Three data points are associated with each instance on a graph that may be used to form a line vertically displayed. A triple includes a size, a price minimum, and a maximum price for a particular size willing to be accepted for a particular minimum or maximum price. Multiple sets of these triples or points are defined. From these lines, and data sets of points, curves may be fitted. This will be shown in other figures and described in paragraphs that follow in performing negotiation and what would be an acceptable counteroffer as well as what offers may be acceptable in accordance with the parameters entered with the screen shot 200c. Once the parameters have been entered, a user may now cause the negotiation process to begin by selecting a submit agent option 280.

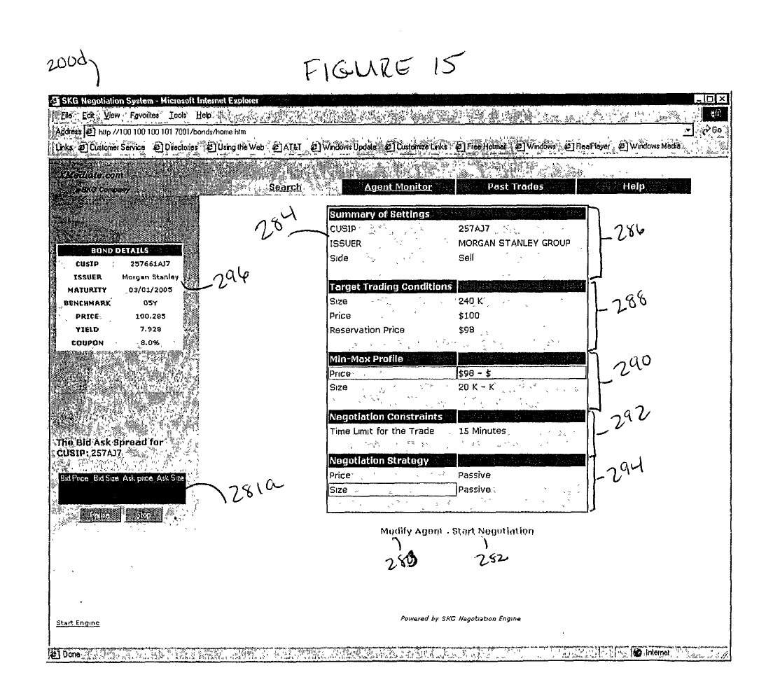

Referring now to FIG. 14, shown is a graphical representation that may be associated with a particular partial fill order in accordance with parameters that may be entered, for example, using screen shot 200c as previously described in connection with FIG. 15. The graph 350 represents the different regions that may be formed as partitioning in accordance with parameters entered in connection with trade attributes, and partial film and max profile information for a single round of counteroffers.

In particular, what will be described is how a curve may be fitted in accordance with the triples just described in connection with FIG. 13. As previously described, triples or a set of three data points form a vertical line. A minimum of two such vertical lines are formed in accordance with three data points each. A first set of triples or three data points is entered and a vertical line is drawn in accordance with what is specified as the target size, target price and min price which are fields 254, 256 and 258 respectively of the user interface or screen shot 200c. In the illustration of graph 350, the vertical line VI may be formed in accordance with a target size previously entered of 240, a target price of 100 and a minimum price of 98. The minimum price of 98 is indicated at point A and the desired or target price is indicated as 100 by data point B. Together, a size of 240 point A and point B as indicated form line VI.

Similarly, in accordance with other information and triples entered in the partial fill min/max profile chart 270, other vertical lines such as V2 may be entered. Line V2 may be formed in accordance with partial fill min/max profile information entered with a minimum size of 20 and a minimum price of 98 and a maximum price of 105 to define vertical line V2. Other triples may be entered, for example, in connection with additional lines in table 270 such as line 276b. If there were other lines formed such as a V3 line with other data points entered, for example, at table entry 276b, a curve fitting technique such as the piecewise linear or other type of curve fitting routines would take these data points into account in forming lines H1 and H2. Together, these four lines define a trapezoidal type of shape defined and bounded by data points A, B, C and D indicated in graph 350. This trapezoidal shape defined by these points A through D define the negotiation region for a single round collectively for one or more orders for this particular transaction. Anything above that falls into what is known as the acceptance region and anything below that falls into the rejection region. The same technique of curve fitting from a plurality of points including a min and a max price in accordance with a particular size may be used in fitting other curves as will be described herein. This graphical representation of regions may be applied to a single iteration or round of counteroffers. Any single counteroffer sent in response to a received counteroffer may fall into any of the regions. This graph illustrates various regions of a snapshot in connection with a single round collectively for all orders.

It should also be noted that what will be described herein is price v. size or a min/max price entered for a particular size. Those techniques that are described herein may also be applied in the instance where there is a min and a max size for a particular price. Additionally, although the techniques that may be described herein in a particular example refer to a buyer or a seller, these may be expanded to apply to the alternate or other. Additionally, although a particular type of security such as a bond may be described, other types of securities including stocks and the like may also be negotiated using the following techniques of automated negotiation process by an agent. Additionally, the general negotiation process and techniques herein may also be applied to any type of the negotiation process where there is a bidding in accordance with a buyer and a seller and entered parameters. This may, for example, be used in any type of an auctioning application for the purchases of other types of securities and commodities or products or services.

It should also be noted that if the partial fill order is not selected, but rather an indication for the alternative of an “all or none” option is indicated in the agent set up as illustrated in the screen shot 200c, rather than have a bounded region formed by four points, for example, as illustrated by graph 350, the acceptance region may be defined as a linear rather than a linear one-dimensional figure rather than as a two-dimensional shape bounded by points A, B, C and D in this example. Conceptually, there is no negotiation in terms of size or partial filling of an order. Only an order of a particular price range which completely fulfills the target size is acceptable. If this cannot be achieved, for example, even if an order may be fulfilled all but one or two units of the target size, none of the particular security is purchased or sold. However, if an order can be filled with a particular size with a price equal to or less than the target price, this offer is acceptable to this particular agent with “all or none”.

An agent may determine the best of a group of acceptable offers if there are more than one acceptable offer or offers in accordance with filling an all or none or a partial fill order. This is described elsewhere herein in more detail.

Referring now to FIG. 15, shown is a screen shot 200d subsequent to submitting the agent as by selecting the submit agent option through button 280 of screen shot 200c. At this point, the agent is created within the application server 44. However, negotiation has not yet begun by the negotiation engine 46 for the particularly identified security or securities. It should be noted that in this example, only a single security or a bond has been selected and associated with a particular session. However, a user may have selected a plurality of securities associated with a single session. If this is the case, as described in connection with other figures, the single agent may participate in negotiations of multiple securities within the negotiation engine 46 on behalf of this particular user.

FIG. 15 with screen shot 200d provides a display of the current agent parameters displayed in tabular form of element 284. In particular, a summary of the settings selected or shown as fields 286, the target trading conditions in fields 288, the min/max profile information in fields 290, the negotiation constraints in field 292, and the negotiation strategy information in fields 294. At this point, the user may modify certain options of the agent previously specified. At this point, the agent from within the application server 44 has now been submitted to the negotiation engine 46. However, negotiations have not yet begun. In terms of implementation, in one embodiment, a procedure call, for example, may be executed from the application server to the negotiation engine to communicate the information necessary to start the negotiation process once initiated by selecting option 282. In other words, information has been transferred between different components such as the application server and the negotiation engine in order to pass information to the necessary objects, processes and the like prior to beginning the negotiation process on behalf of the particular agent. The selection of the submit agent button 280 causes this process to occur in this particular embodiment.

At this point, screen shot 200d may be displayed to a user and the system may be poised and ready to begin negotiation process when initiated by the user such as, for example, by selection of the start negotiation process 282. However, the user may modify agent information that displayed in table 284 prior to beginning negotiations. It should also be noted that at any point in time during negotiation process a user may additionally modify information in table 284.

For example, the user may choose to extend the time limit for the trade as indicated in field 292. Additionally, a user may find through the viewing of interactive feedback information in the area 281 a that prices should be adjusted. For example, the market may be going up or down. Accordingly, the perception going into a negotiation process as to what would be an acceptable price may change during the course of negotiations. A buyer going in at a certain price may notice that other transactions of the same or similar security, commodity, and the like are closing where buyers are paying less than the target price specified by this particular buyer. Accordingly, the buyer may quickly choose to lower his or her price since they may be able to purchase the same quantity and the same bond for example at a lower price. Similarly, a seller may also change different pricing information in accordance with current market conditions for the negotiation processes ongoing in the system as displayed in field 281a.

An embodiment may include additional information in a feedback area reflecting current market information as well as the status of transactions ongoing in the ETS 40. After an agent's information has again been checked by a user, the start negotiation button may be selected 282 from the screen shot 200d causing the negotiation process to begin on behalf of this particular user by the agent in accordance with the agent set up information specified for the selected security or securities.

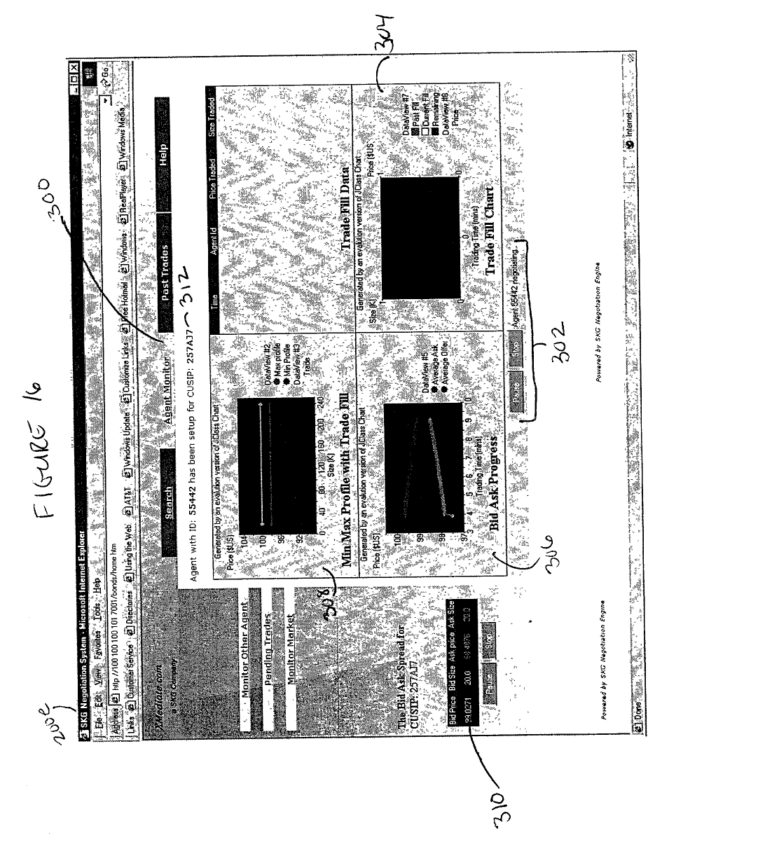

Referring now to FIG. 16, shown is an example of the screen shot 200a that may be displayed in connection with monitoring the agent of this particular session. Different types of information may be displayed to a user in accordance with monitoring the agent activity. For example, graphically displayed in a portion of screen 306 is the progress of bidding and counteroffers for this particular agent. Additionally, user feedback may be presented in area 302 indicating that the agent is currently negotiating. Accordingly, as additional offers and counteroffers are made, graphical information may accordingly be updated as the in the graphical display 306.

Other types of monitoring functionality may be included in an embodiment. In this example, the agent monitoring software may be included in the application server 44. Different options may be displayed in accordance with different buttons displayed next to the agent monitor button 300. For example, a user may want to monitor past trades done as well as the market. This may be selected by selecting the appropriate buttons from any particular screen display. The particular functionality included in an embodiment may vary with each embodiment.

In this particular example, the information accessible to an agent is either public information such as market conditions and system wide statistics, and that agent's specific private information. Different security measures may be taken within a system, for example, to monitor the progress of another agent. However, in this example as a security measure negotiation processes are performed in an anonymous fashion and for security reasons, one is only able to monitor the particular progress of their own agent.

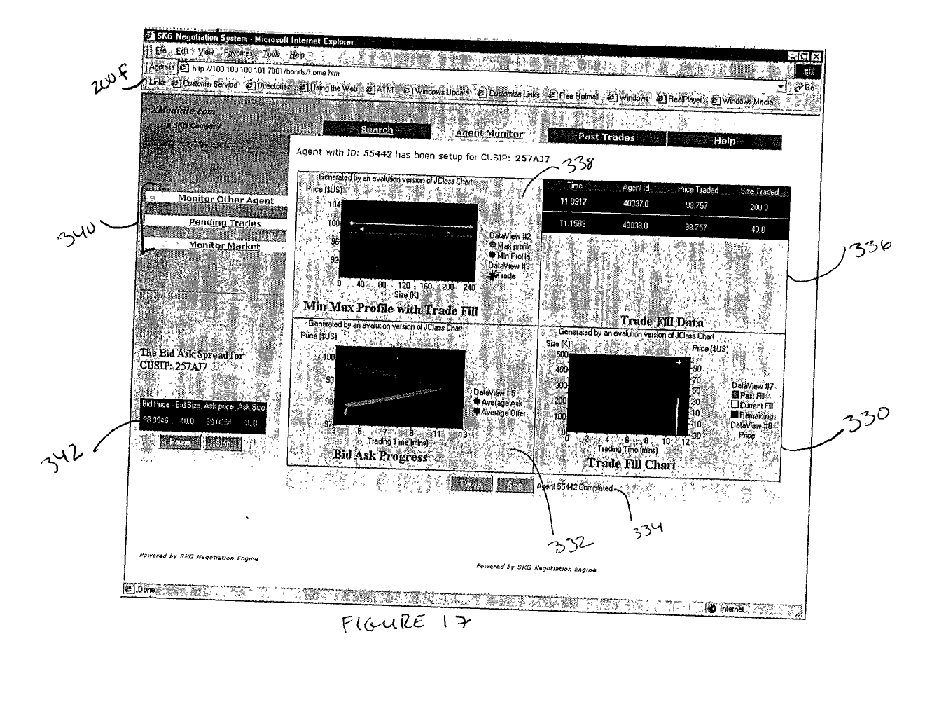

Referring now to FIG. 17, shown is an example of an embodiment of a screen shot 200f displaying agent monitoring in progress at the close or completion of a transaction. In other words, the screen displayed in screen shot 200f includes graphical illustrations which indicate that the agent has completed negotiations for a particular order as requested. The information in screen portion 332 includes a graphical display of the progress of a particular bidding and counteroffering process. This may be for example an update if it was included in the previous screen shot 200e. The status of the agent's progress is indicated as completed in screen portion 334. The number of orders filled is indicated in screen portion 336 as well as additional information such as the price and size traded, the agent identifier and the particular time that the transaction took in duration. Additionally, displayed in screen portion 338 is where the particular trades indicated in screen portion 336 fit in with the min./max. profile for the particular users agent information.

The foregoing illustrates from a user's perspective what may be displayed in various screen shots as an agent negotiates on behalf of a particular user in accordance with parameter information entered. This is an automated type of negotiation which includes biases or weights for example in accordance with the target size and price and other preferences entered by the user. The negotiation process or technique executes with offers and counteroffers such that there is a bias towards the preference specified.

It should also be noted with reference to FIG. 16 in screen shot 200e, that a user may select by various options such as through the stop button to stop the negotiation process. In other words, the foregoing automated technique is that human intervention may be combined with the process of automating the buying and selling in a particular transaction. In this particular embodiment, the stop selection may terminate negotiations all together, as well as a selection of a pause for example may provide an option for user to update and put parameters used in determining counteroffers in accordance with agent parameters such as a price strategy or a size strategy.

As part of this process profile information with regard to a particular user and his or her one or more agents for the varying transactions or session may be stored in the trading database 48. In other words, a user may go through an account creation process using the web server 42 and subsequently, default information and preferences may be stored in the trading database 48 and used in subsequent transactions when the user logs on for example in a subsequent session in accordance with a particular user id.

Any one of a variety of different types of architectures may be used in accordance with the techniques described herein. One or a plurality of different processors as well as different network configurations may be used in accordance with a particular embodiment. In one example described herein, different types of processors may be used and associated with each of the different functional boxes such as the application server having a dedicated processor in the negotiation and to executing on a different processor connected to the application server through a network or other type of connection. All of the components of the ETS 40 may reside on a single machine or in a single system with a plurality of processors. Precisely what functionality is executed or associated with what particular processor may vary in accordance with each particular system and the traffic anticipated under a particular processor. Similarly, each component such as the negotiation engine individually by the application server individually may be developed as an application for example that runs as a distributed application or as a single application. It may also run as a multi-threaded application or other type that varies in accordance with each particular embodiment.

As described herein in connection with the screen shots, in determining a price, any one of a variety of different types of data may be used by a particular user and their associated agent. In one embodiment, a buyer may determine their particular price in accordance with current market conditions. In another example, a buyer may determine the particular price based on those buyers and sellers currently executing in the negotiation engine for example in accordance with information displayed with a dynamic feedback information with regard to those transactions ongoing on the ETS 40 for example as displayed in area 310 of screen shot 200e or area 342 of screen shot 200f.

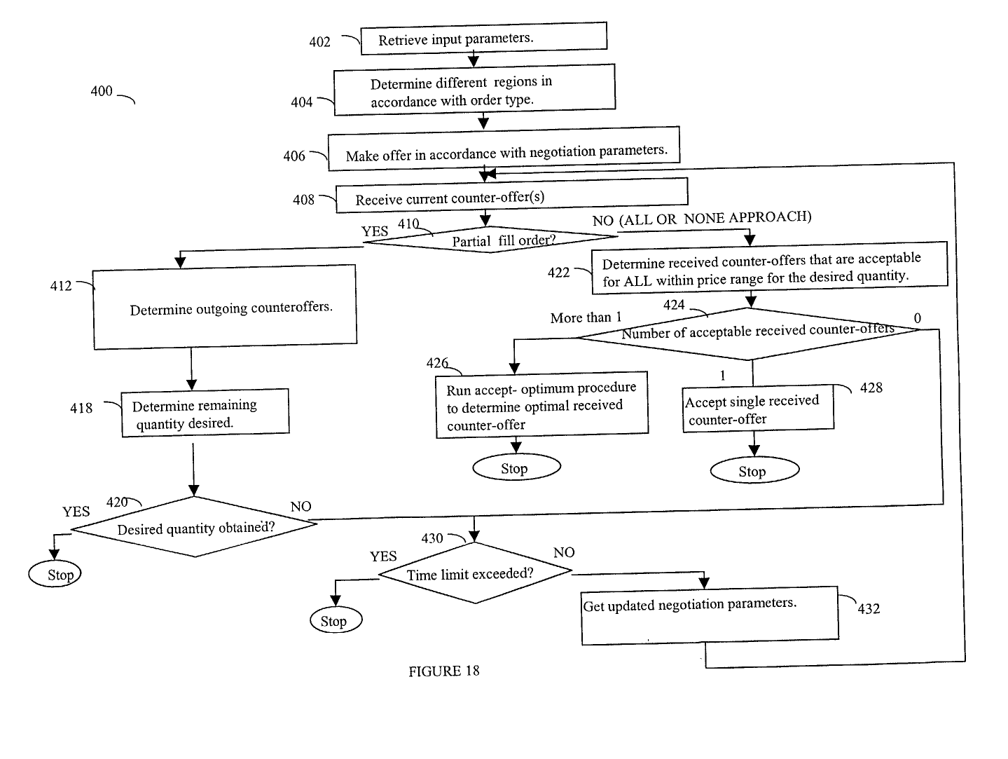

Referring now to FIG. 18, shown is an example of the steps of an embodiment and flowchart 400 outlining the general process of negotiation that may be performed in an embodiment of the negotiation engine. At step 402, input parameters are received for example from the application server. It should be noted that these input parameters include the negotiation parameters and other inputs described in connection with screen shots described elsewhere herein. At step 404, different regions are determined in accordance with the order type. At step 404 as described also elsewhere herein, the different regions which include accept, reject, and negotiation regions are determined in accordance with each of the order types and parameters. Recall that in connection with a partial fill order, a different negotiation region is determined that differs in characteristic from that of a negotiation region with an all or none order. At step 406, an offer is made in accordance with the negotiation parameters. This step may be used in formulating an offer as well as counteroffers as described in more detail in accordance with other figures. At step 408, counteroffers are received from other agents operating in connection with other transactions for the same security for example at step 410, a decision is made to determine whether the current orders for a partial fill or an all or none in accordance with parameters input and associated with a particular agent. If at step 410 it is determined that there is a partial fill order, control proceeds to step 412 where outgoing counteroffers are determined.

At step 418, the remaining quantity desired in connection with fulfilling the partial filler with the desired quantity is determined. Control proceeds to step 420, where it is then determined if the desired quantity previously entered has been obtained. If so, control proceeds to stop because we have fulfilled our order in accordance with previously entered criteria. Otherwise, if the desired quantity has not been obtained for our order, control proceeds to step 430 where another determination is made if time limit has exceeded. If time limit has exceeded, the current process stops. Otherwise, control proceeds to step 432 where any updated negotiation parameter values are input. Subsequently, control proceeds to the top of the loop at step 408 where counteroffers are received for the next round or iteration.

At step 410, if it is determined that our current order is not for a partial fill, it is determined that we have an all or none approach and control proceeds to step 422 where it is determined if any received counteroffers are acceptable for all of the quantities specified within the price range for the desired quantity. Control proceeds to step 424 where a determination is made in the three-tier division in accordance with the number of determined acceptable offers counteroffers received. If there is more than one counteroffer, control proceeds to step 426 where an accept optimum procedure is executed to determine the optimal received counteroffer from all of those received. If at step 424 it is determined that there is a single counteroffer that satisfies all of the quantity, control proceeds to step 428 where that single counteroffer received is accepted and processing subsequently stops. If it is determined at step 424 that the number of acceptable receipt to counteroffers is zero, control proceeds to step 430 where a determination is made as to whether the time limit is exceeded. Processing proceeds from that as previously described in connection with the processing at step 430.

What will now be described are some concepts that may be used in this embodiment in formulating a counteroffer and evaluating the current offers.

It should be noted that the negotiation strategies and techniques that will be described herein are effective in particular by several different parameters that may be entered for example in connection with the previously described screen shots or user interface displays. In particular, pricing strategies as aggressive or passive for example may effect the strategies chosen by a particular agent. For example, an aggressive strategy may cause an agent to make trades sooner as it aggressively tries to fill as many trades as possible in order to meet the targets and constraints as the time lapses closer to termination in accordance with the previously entered time limit. In contrast, a passive strategy may delay making the trades towards a later stage of negotiation. Similarly, if an agent's profile information and parameters are biased towards lower sizes for example as compared to other agents, lower size trades may be favored.

It should also be noted that every offer and every counteroffer for a partial fill order represents a curve or a line in accordance with particular parameters as will be described herein. For an all or none, this is a single point.

What will now be described are additional concepts that play a role in determining the negotiation strategy and an evaluating offers and formulating counteroffers. A utility profile may be modeled as two price sized curves from a minimum profile and a maximum profile. In accordance with what is described elsewhere herein, the minimum profile corresponds to a minimum satisfaction level or a utility of zero and a maximum profile corresponds to a maximum level of a utility of one. A particular utility associated with a point that lies somewhere between these two curves or lines may be linearly interpolated for a particular price.

Referring back to FIG. 14, the minimum profile may correspond to line H2 for between the quantities or sizes 240 and 20 as identified as corresponding to points C and A. The maximum profile or line may be defined as line Hi as determined between points B and D. Accordingly, for a particular size, a utility of zero may be associated with the minimum profile line in this case point C with a value of 98 and a utility of one may be assigned or associated with the maximum profile line at that particular size for a value of point D of 105. In this example, any points which lie in between those are linearly interpolated to be assigned a utility between zero and one. Similarly, other types of indices are described elsewhere herein which a normalized value between zero and one may be used to describe a point lying in between having a value that may be determined by linear interpolation.

A response index may be used in an embodiment. Generally, the response index is a curve that represents a series of optimal prices, each price determined in accordance with selected quantities and prices of the counteroffers from one particular round. In other words, for each round of counteroffers received, there is one response index calculated representing a weighted price for a particular size taking the best determined combination to fulfill that size, for example, for each size between V1 and V2 as represented in FIG. 14 in a receiving agent's profile.

A target index may also be used that is a quantity also between zero and one representing a proximity to the desired target values previously entered with respect to the past performance. Also similar to the response index, the target index is calculated as a single value for all of the counteroffers from one particular round representing also a weighted average in accordance with different criteria.

An offer index is an index also between zero and one calculated for each particular counteroffer for each round. In other words, if there are five counteroffers, there would be a single target index, a single response index, and five offer indices in which there is a single offer index corresponding to each counteroffer. Generally, the offer index represents for a particular offer how this offer is weighted in terms of our utility. The goal is to measure the goodness or the badness of a particular offer and subsequently formulate a counteroffer.

An urgency factor is also used in calculations which is a quantity that represents the perceived urgency of obtaining a satisfactory transaction to fill an order. This may be represented as, for example, an faggressive function in following descriptions.

An estimated response index is also calculated for example in connection with calculating no response index in which the estimated response index represents a time series analysis of the past responses.

Each of these indices may be a contributing factor used in the negotiation strategy for determining a counteroffer index which is also a value between zero and one corresponding to a curve or line as will be described in more detail elsewhere herein. Generally, the counteroffer index is a value between zero and one which through reverse interpelation may be used to calculate a series of points that represent a data point corresponding to a price for a particular size as interpolated between a minimum and a maximum profile price lines as previously described elsewhere herein.

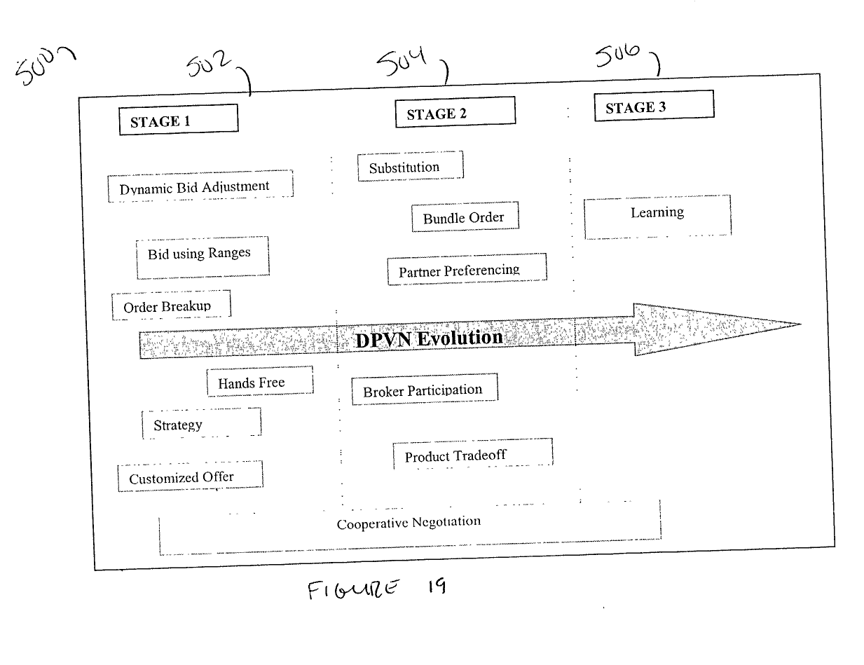

Referring now to FIG. 19, shown is an example of a process that shows the progression or different phases within which an embodiment may include different functionalities associated with the negotiation process. For example as shown in stage 1 element 502, there may be dynamic bidding as well as using ranges and a breakup of the order for those for example partial fill orders. At stage 2 504, an embodiment of the negotiation engine may also include in addition to all of the functionality included at stage 1 additional functionality. In this example, the additional functionality may include for example substitutions of similar or like securities or products, provide for bundling of orders as well as partner preferencing. Generally, a bundle order is using a combination of buy and sell orders to form a combination of a single order for a product. Partner preferencing may generally be defined as that arrangement between particular firms to give some vendors special treatment in connection with transactions while keeping them competitive in terms of business. In other words, this additional factor may be used in the negotiation strategies or in determining acceptable prices as well as in formulating counteroffers.

Yet another embodiment of the negotiation engine may include all of those functionalities described in connection with stages 1 and stages 2 and also include additional functionality listed at element 506 stage 3. In this example, the negotiation engine operating in accordance with stage 3 506 elements may include a learning function to continuously evolve and adapt strategies and approaches as the particular processor model learns as time lapses. Such learning processes may include for example EM learning, use of neural nets and weights and other techniques known to those skilled in the art in determining negotiation strategies.

Generally, FIG. 19 shows different degrees of functionalities that may be associated with a particular embodiment of the negotiation engine. One particular embodiment may include any combination of futures or functionality described herein as well as other types of functionalities associated with different phases.

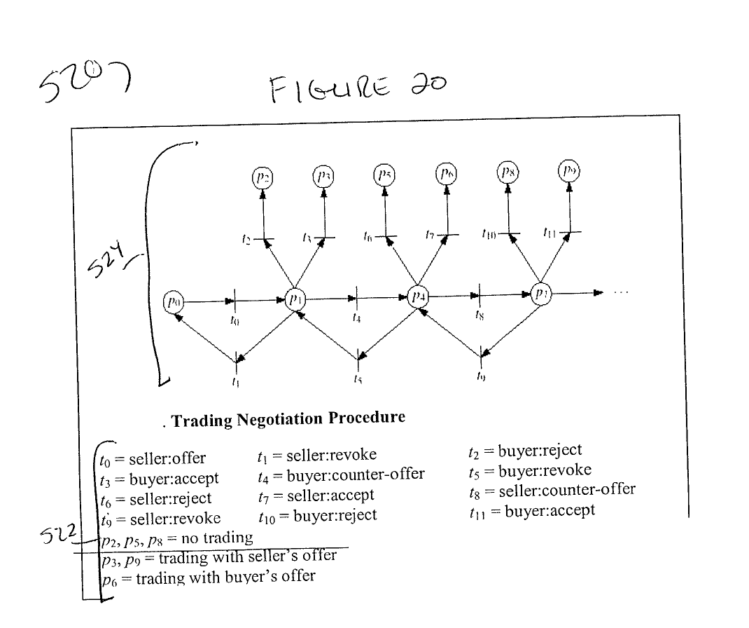

Referring now to FIG. 20, shown is an example of a representation of a transition or state diagram representing the states of the trading negotiation procedure within one embodiment. Generally, the states are represented in portion 524 as P0, P1 and the like. Transitions occur between states through arrows for example upon the occurrence of certain events. Definitions for each of the states in transitions are described generally in connection with portion 522. The negotiation process described and represented by the state diagram 520 is generally that which is described in connection with flowchart 400. Generally, negotiations starts with a trader's offer to buy or sell a product under certain trading terms such as a particular price or size. An offer is represented as an array of trading attributes such as a variety of plurality of price and size points. Upon a seller's offer, a buyer accepts the offer, rejects the offer or proposes a counteroffer or some combination thereof for example in connection with filling partial orders where a portion of the offer may be accepted in a counteroffer for the remaining quantity may be formulated. Upon the buyer's counteroffer, the seller may accept the counteroffer, reject the counteroffer or propose a further counteroffer. This process of bargaining may continue until the buyer and seller reach a conclusion where a conclusion or final state may be defined as an complete acceptance for the case of a partial order, a complete rejection or until one of either the buyer or seller withdraws from the negotiation process for example in accordance with a time limit being exceeded.

It should be noted that in connection with the processing of a negotiation, a user may intervene to terminate negotiation processing. How a particular embodiment implements this may vary. For example, in one embodiment, the condition of whether a user has intervened to terminate negotiation processed may be tested in connection with flowchart 400 at step 30 in addition to the condition evaluated in determining if the negotiation time limit has exceeded. This technique provides for termination through user intervention in a synchronized fashion in connection with the processing of the negotiation strategies.

Other embodiments may implement this using other techniques rather than test for this user intervention for terminating negotiations at a particular point in processing. For example, user intervention termination processing may be implemented in an embodiment, for example, using asynchronous programming techniques such as using interrupts. Thus, rather than terminating in a synchronized fashion in accordance with the processing of a particular step such as at step 430, the negotiation process may terminate at any point in processing the interrupt in accordance with each particular embodiment.

As described in this embodiment herein, an “agent” acts in negotiations on behalf of a user for a given transaction with regard to a particular security. This agent as described elsewhere herein, takes into account certain inputs or parameters such as those provided in accordance with profiling information. These may include, for example, the maximum time duration for the negotiation which includes the maximum user specified time for the negotiation process to come to completion. Additional information includes the target size and the target price as well as the strategy regarding price and size, such as an aggressive or moderate strategy, as described elsewhere herein. Other information that may be specified in accordance with user profile information for the particular transaction includes whether an order is a “partial fill” order, or an “all or none” order.

For a partial fill order, as described elsewhere herein, there are two price size curves, a first representing the lower limit and another representing an upper limit. For “all or none” order, two prices may be specified to define an acceptable price range, one representing the lower bound and one representing the upper bound.

For each agent with a partial fill order, the profile may be modeled as two price size curves as described in connection with other figures. The minimum profile corresponds to the minimum satisfaction level representing a utility of zero. The maximum profile corresponds to a maximum satisfaction level with a utility of one. The utility of a price size point line within the minimum maximum profile, such as in the negotiation range may be lineally interpolated in accordance with size. This implicitly tries to attain the maximum size for a given price for a trader or a minimum price for a given size for a trader. Also in accordance with whether an offer is accepted or rejected, a point line below the minimum profile has the utility of zero and it is rejected. A point that lies above the maximum profile has the utility of one and may be accepted.

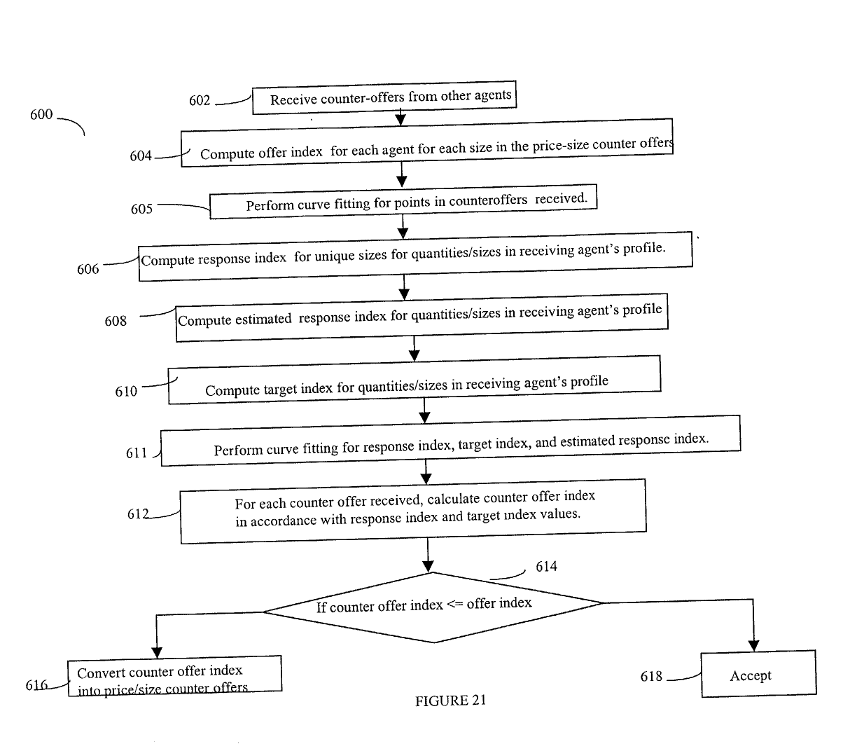

Referring now to FIG. 21, shown is a flowchart of steps of one embodiment that may be included showing more detail for formulating the counteroffers in accordance with one embodiment. Note that some of the steps of flowchart 600 include the processing steps that are more detailed processing of those previously described in connection with FIG. 18. In one embodiment, these steps are associated with forming one or more counteroffers in connection with either a partial fill or an “all or none” order.

Other embodiments may uses these techniques with either one or both of the order types and may alternately use another technique. For example, an embodiment may use the technique to be described using the various indices in connection with a partial fill order and use a second different technique in connection with “all or none” orders. An embodiment may also use the same techniques without differentiating between order types in forming counteroffers. It should be noted that for partial fill orders, techniques described herein may be performed forming a curve using a plurality of sizes or quantities. The same techniques may also be applied and used in connection with “all or none” orders in which there is only a single size or quantity.

Referring now to FIG. 21, at step 602, counteroffers are received from the other agents for a given security. At step 604, an offer index is computed for each agent for each size in each agent's counteroffer. At step 605, curve fitting is performed for points received for each counteroffer. At step 606, a response index is computed for sizes included in the particular profile of the negotiation parameters associates with the receiving agent (“my profile”). At step 608, an estimated response index is computed for each size of interest in the profile of the receiving agent. At step 610, a target index is computed for each size included in the receiving agent's profile. At step 611, curve fitting is performed for each of the response index values, the target index values, and the estimated response index values. At step 612, for each counteroffer size received, a counteroffer index is computed in accordance with the estimated response index, response index and target index values. It should be noted that this step will be described in more detail. In one embodiment, six conditions are possible in which different formulas may by used in calculating counteroffer index in accordance with values of the response index and target index values.

Control proceeds to step 614 where determination is made if the counteroffer index is less than or equal to the offer index. If at step 614 the counteroffer index is not less than or equal to the offer index, control proceeds to step 618 where the offer is accepted. It should be noted that the processing of step 618 corresponds to some of the processing of step 414 previously described in connection with FIG. 18.

It should be noted that a counteroffer or portion thereof may be “accepted” between agents negotiating on behalf of different users for the same commodity using any one or more different techniques and protocols. For example, one embodiment may have an agent receiving a first counteroffer return a second counteroffer. The second counteroffer may include an indication of acceptance of a portion of the first counteroffer as well as a portion that represents that which has not been accepted but is being negotiated. For example, an embodiment may transmit of a series of points representing a curve in which the series of points include those which are accepted as well as those under negotiation (being counteroffered). Another embodiment may handle the accepting of a portion of the first counteroffer using a first message and separately transmit a counteroffer of that under negotiation rather than communicate both acceptance and that under negotiation in one communication. This may vary in accordance with each embodiment.

If , at step 614, a determination is made that the counteroffer index is less than or equal to the offer index, control proceeds to step 616 where the counteroffer index calculated is converted into a price size counteroffer. In other words, the counteroffer index which is described in more detail elsewhere herein is actually an interpolated value. This interpolated value or values are converted into price size counteroffers which may then be transmitted to each of the other agents for a given security.

An embodiment may determine an initial offer in any one of a variety of different ways. In one embodiment, an initial offer for a seller may be determined by using a maximum price as entered in accordance with negotiation parameters. For a buyer, the minimum price may be that price which is included in an initial offer communicated to the different agents for a given commodity or security. Any one of a variety of other different pricing techniques may also be used in accordance with formulating an initial offer for example in connection with the processing of step 406 with an initial offer rather than formulating an offer in response to one or more received counteroffers from various agents for a given security.

An initial offer may be expressed as a plurality of points defining a curve or line. Each point may be a price and size, for example, that may be plotted on a graph similar to that described in connection with FIG. 14. Values for these points may be, for example, those specified in connection with initial input from the one or more user interfaces or screen shots described elsewhere herein such as target price and quantity, or maximum price and quantity. In connection with processing of step 604, an offer index may be determined for each size included in each counteroffer received. The offer index represents a utility value between 0 and 1 with respect to the min/max profile for partial fill orders. Thus, the offer index is a curve formed from a series of points somewhere between the min/max profile for partial fill orders.

In connection with processing of step 606, a response index may be determined for size “s” in a receiving agent's profile. As described elsewhere herein, this represents the average net value, such as the maximum price for a seller or minimum price for a buyer. The response index may be represented as a curve formed by a series of points determined as:

For each size “s” in a receiving agent's profile, the maximum price(s) for seller or minimum price (s) for buyer represented as:

$$price ( s ) = {\sum }_{k = 1}^{n} \frac{( {S}_{k} * {P}_{k} + TC ( {S}_{k} ) )}{s}$$

where

Sk is the partial size of agent k's offer that is matched, Sk<=maximum size agent is willing to consider;

Pk corresponds to the price corresponding to Sk;

TC(Sk) are the transaction costs associated with a transaction of this size Sk; and

n is the total number of counteroffers received; and k>=1 and k<=n.

The above price(s) may be translated into a response index by linearly interpolating this price between a minimum and maximum price for this size in accordance with profile information of a receiving agent.

The foregoing response index may be computed using the “best” Y prices as determined above for particular sizes. The estimated response index at step 608 may be determined by using past response indices for a particular size. The estimated response index captures what is expected in the next time step of negotiation in accordance with previous values of the response index by linearly interpolating the two previous response indices represented as:

estimated_response_index=(2* response_index)—prev_response_index

estimated_response_index=min(1, max(0, estimated_response_index)).

At step 610, the target index is computed for each size in the receiving agent's profile. target_index values range inclusively between 0 and 1. Generally, the target index may be initially 1 and tends to converge towards 0 as timelimit of the agent expires, and/or the desired quantity is reached as time progresses. The target index calculation for an agent at time t takes the following input values:

Inputs

1) The ratio of time spent (t) to time limit of the agent (Note: this time limit may be specified by user at the start in the negotiation attributes section). We define the variable(fractional time spent) FTS=t/timelimit

2) Whether the agent is aggressive or passive. We define a variable aggressive=1 means a strategy of aggressive was selected, aggressive=0 means a strategy of ‘passive’ is selected in the agent negotiation attributes selection.

3) A new flag may be used indicating whether the current market conditions are to be considered. This may be represented in the calculation as a change in the demand-supply ratio (dsratio=demand/supply) in the market (there is a flag called dsflag to enable this). This may be specified, for example, by the user through one of the screen shots or other user interface inputs.

Equation 2 Sets

Set 1: Without demand supply flag (dsflag)

(Note: “exp” is the exponential function)

if aggressive=1

target_ndex=faggressive(FTS);

faggressive(FTS)=((exp(−FTS)−exp(−1))/(1−exp(−1));<−this function goes down to zero

faster

if aggressive=0

target_index=fpassive(FTS);

fpassive(FTS)=(exp(1)−exp(FTS))/(exp(1)−1);<−this function goes down to zero

slowly

Set 2: Demand Supply Flag is on

New Variable Definition:

size_remaining: size remaining to sell/buy for this agent.

(1−FTS): fractional time remaining. FTS was fractional time spent

total_size: refers to initial total size intended to sell/buy and set by the user in Trading Attributes

section of input.

dsratio: defined as demand/supply; demand=sum of all users with side set to ‘buy’ target size;

supply=sum of all users with side set to ‘sell’ target size

for seller

STEP 1

effective_time_left=size_remaining* (1−FTS)/total_size;<−effective_{—time_left is initially} 1, goes down to 0 as time progresses and faster if you are getting a lot of size done.

STEP 2

faggressive=1

faggressive(FTS)=((exp(−FTS)−exp(−1))/(1−exp(−1));<−this function goes down to zero

faster

temp_target_index=faggressive(FTS)

if aggressive=0

fpassive(FTS)=(exp(1)−exp(FTS))/(exp(1)−1);<−this function goes down to zero slowly temp target_index=fpassive(FTS)

STEP 3

updated_target_index=temp_target_index* (1+effective_time_left *(dsratio−1))<−if you are a seller and demand is higher than supply then you can be afford to demand a higher price by upping your target_index. This is also weighted by effective_time_left—if that's high than you can afford to up your target index more.

target_index=min(1, updated_target_index); values are <=1

for buyer

STEP 1

effective_time_left=size_remaining* (1−FTS)/total_size;<−effective_time_left is initially 1, goes down to 0 as time progresses and faster if you are getting a lot of size done.

STEP 2

if aggressive=1

faggressive(FTS)=((exp(−FTS)−exp(−1))/(1−exp(−1));<−this function goes down to

zero faster

temp_target_index=faggressive(FTS)

if aggressive=0

fpassive(FTS)=(exp(1)−exp(FTS))/(exp(1)−1);<−this function goes down to zero

slowly temp_target_index=fpassive(FTS)

STEP 3

updated_target_index=temp_target_index* (1+effective_time_left*(1/dsratio−1))<−if you are a buyer and demand is less than supply then you can be afford to demand a lower price by upping your target_index. This is also weighted by effective_time_left—if that's high than you can afford to up your target_index more.

target_index=min(1, updated_target_index);<−restrict to <=1

Different techniques may be used in evaluating what counteroffers, or portions thereof are acceptable. This may be performed in connection with an accept-optimum procedure, for example, as part of steps 416 and 426 processing. Additionally, different techniques may also be used in further ranking those offers determined to be in the acceptable range. One embodiment may include a simple strategy of just taking the first acceptable counteroffer. Another embodiment may take those in the order of lowest price for an agent negotiating on behalf of a buyer, and in the order of highest price first for an agent negotiating on behalf of a seller.

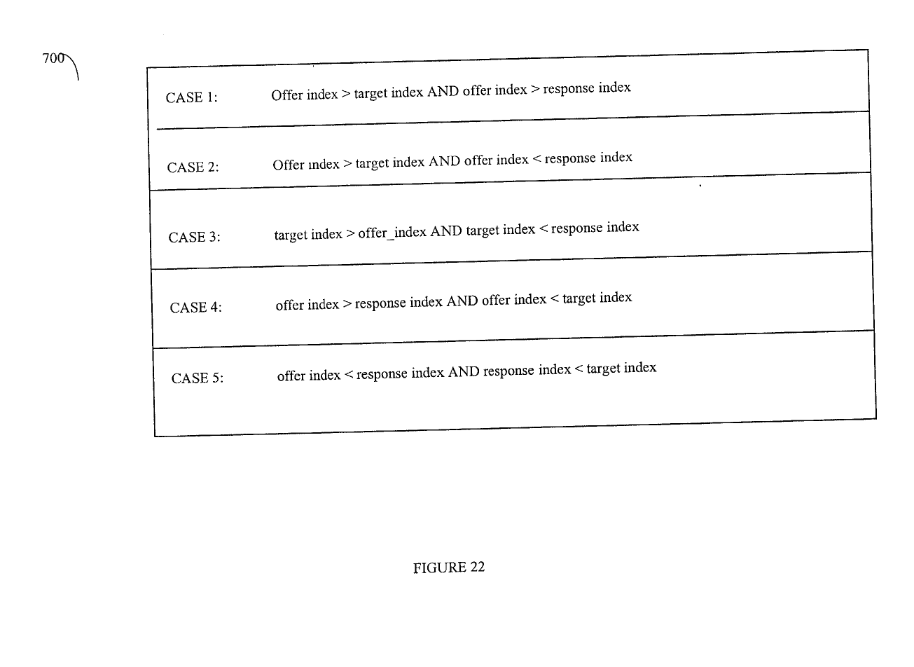

Referring now to FIG. 22, shown is a table 700 outlining the possible cases in accordance with the different values of the indices. For each of the following cases included in the table 700, the counteroffer index may be determined as will be described. It should be noted that the counteroffer index is also a line representing a series of points. This index is also an interpolated value. Thus, to communicate a counteroffer to one or more agents, the counteroffer index curve has a series of points converted to price size points using reverse interpolation in accordance with the min/max profile. For “all or none” orders, this is a single point.

For CASE 1, the counteroffer received from the agent is accepted or deemed an acceptable offer from which one or more acceptable counteroffers , or portions thereof, may be accepted.

For CASE 2, the counteroffer index is between the offer index and the response index. In particular:

counteroffer index=response index−r_change*(response index−offer index)

where

r_change=

$$MIN \frac{max ( response index - estimated\_response \_index , 0 )}{( response index - offer index )} OR 1$$

In other words, in connection with CASE 2, if the estimated response index is greater than the current response index, then r_change is zero indicating that the counteroffer index is the same as the response index. However, if the estimated response index is lower than the offer index, then r_change is 1 in that the counteroffer index is the same as the current offer index. If the estimated response index is between the offer index and the response index, then r_change is the ratio defined above reflecting the fact that if the market is moving below the current demand as reflected by the response index, and approaches the current offer index, then the counteroffer index also approaches the offer index.

For CASE 3, the counteroffer index may be defined as:

response index−r_change (response index−target index)

where

r_change is defined as:

$$MIN \frac{max ( response index - estimated\_response \_index , 0 )}{( response index - target index )} OR 1$$

That is, if the estimated response index is higher than the current response index, then r_change is 0 in that the counteroffer index is the same as the response index. If the estimated response is lower than the target index, then r_change is 1 in that the counteroffer index is the same as the target index.

For CASE 4, the counteroffer index may be computed as:

max {target index−r_change*(target index−offer index), offer index}

where

r_change is defined as

$$MIN \frac{max ( estimated\_response index - response\_index , 0 )}{( target index - response index )} OR 1$$

For CASE 5, if the response index is falling, the counteroffer index is between the response index and the offer index. If the response index is rising, the counteroffer index is between the target index and the offer index. In particular, when

r_change <0.5, then

counteroffer index=target index−(2*r_change)*(target index−response index); and

when r_change >=0.5, then

counteroffer index=response index−[2*(r_change−0.5)]*(response index−offer index); and

when estimated_response_index>response index, then

r_change =0.5 max {( estimated_response_index−response index),0}/

(target index−response index)

otherwise:

r_change=0. 5*min {(response index−estimated_response_index)/

(response index−offer index),1 } +0.5

What will now be described is an example using the foregoing to determine a counteroffer in accordance with principles and techniques described herein for a partial-fill order.

Example

Consider my seller agent, say agent, is negotiating with agent₁, agent ₂, agent₃ at t=13.

Let the result of the optimization problem give me the following outcome for sizes that range from 55 K through 100 K (at increments of 5), i.e. 55 K, 60 K, 65 K.

Using my strategy my target at t=13 could be:

100 K shares @ 96 minimum

Counter-offers for size=60 K is indicated below. Similar calculations can be performed for other sizes.

Size 60 K

Output of

max (price(s))=97.83

agent₁: {97, 10 K}

agent₂: {98, 20 K}

agent₃: {98, 30 K}

agentₘᵢₙ_{_{—}}_{price}(size=60 K)=96.5

agentₘₐₓ_{_{—}}_{price}(size=60 K)=99.5

Offer Index

agent₁: (97−96.5)/(99.5−96.5) 0.17

agent₂: (98−96.5)/(99.5−96.5) =0.5

agent₃: (98−96.5)/(99.5−96.5) =0.5

Response Index

max (price(s) )=97.83

Therefore,

ResponseIndex=(97.83−96.5)/(99.5−96.5) =0.44

Target Index

TargetIndex=1−(agentₘᵢₙ_{_{—}}_{price}*size/min_target_price*target_size)

i.e

TargetIndex=1−(96.5*60 K/96*100 K)=0.4

Estimated Response Index (at t=14, size=60 K)

0.42 (on basis of time-series analysis and market inputs)

Counteroffer to agent,

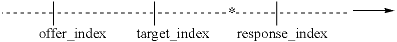

If the target_index is higher than the offer_index but lower than the response_index, the counter_offer_index is between the response_index and the target_index.

counter_offer_index=response_index−r_change*(response_index−target_index) where response_change_index (r_change). This is defined as

$$counter\_offer \_index = response\_index - {r\_change}^{*} ( response\_index - target\_index ) where response\_change \_index ( r\_change ) . This is defined as$$

$$min \{ \frac{max ( response\_index - estimated\_response \_index , 0 )}{( response\_index - target\_inde )} , 1 \}$$

$$That is , if the estimated response\_index at is higher than the current response\_index , then the index is 0. This implies that the counter\_offer \_index is same as the response\_index . \\ If the estimated response\_index is lower than the target\_index then it is 1.$$

$$This implies that the counter\_offer \_index should be the same as the target\_index .$$

That is, if the estimated response_index at is higher than the current response_index, then the index is 0. This implies that the counter_offer_index is same as the response_index.

If the estimated response_index is lower than the target_index then it is 1. This implies that the counter_offer_index should be the same as the target_index.

Here, r_change=0.02/0.04=0.5

Therefore,

counter_offer_index−0.44-0.5*(0.44-0.4)=0.42

This corresponds to a price of

96.5+0.42*(99.5-96.5)=97.76

Hence a counter_offer point to agent₁ is {price=97.76, size=10 K}

Counteroffer to agent₂

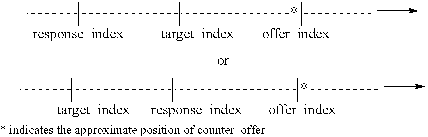

If offer_index is higher than both the target_index and the response_index, the estimated counter_offer is same as the offer.

Hence a counter_offer point to agent₂ is {price=98, size=20 K}, i.e. there is a match

Counteroffer to Agent₃

Similarly, there is a match for agent₃ and calculations performed in accordance with descriptions herein.

It should be noted that the number of points included in an offer, counteroffer and the like may be determined in accordance with a specified granularity parameter, such as, for example, for every 5 K of quantity or size. In accordance with this granularity, a particular number of points may be considered for every curve and calculations performed.

What will be described in connection with several figures are class diagrams describing information and corresponding interactions between entities in one embodiment of the ETS.

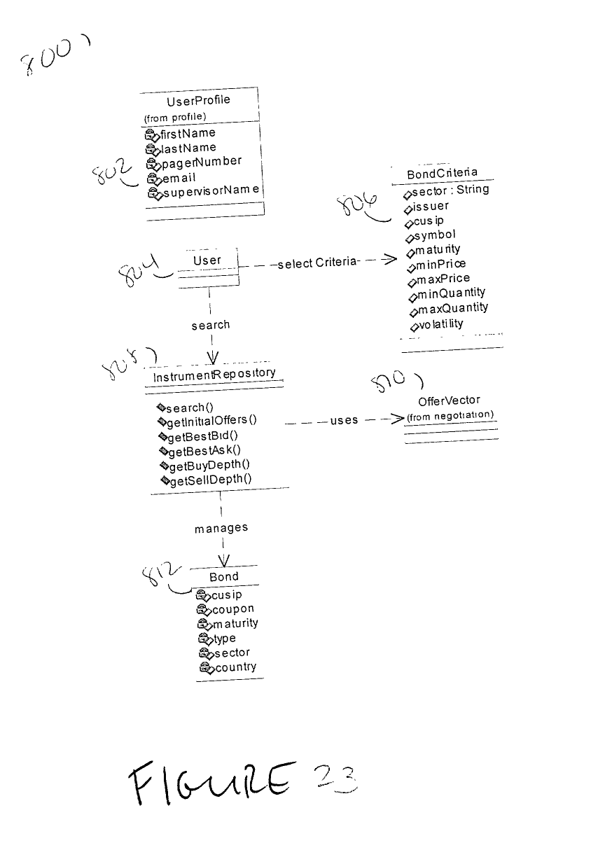

Referring now to FIG. 23, shown is an example of a class diagram of a representation of data that may be included an embodiment in connection with performing a search of security information and initially selecting a security in anticipation of negotiation. In other words, the data representation 800 is an example of the relationships between data entities that may be included in a database of the ETS. The database may be used, for example, in connection with performing a user query for bond, stock, or other security information.

Data entity 802 includes user information as may be associated with user profile information stored in the database of the ETS. This information may include user name, and contact information including e-mail addresses and pager number, as well as additional information. The particular data associated with a particular instance of a user may vary for each user and may be stored in the database similar to account information that may be reused in an embodiment in subsequent sessions and initially provided in the first session or in connection with an account creation for the particular user 804. User profile information may also be stored and obtained from an external source other than within the ETS database.

When a user logs onto the ETS, a user object 804 may be created corresponding to the particular user session. The user 804 may select particular criteria corresponding to a security of interest. In this example, the security of interest is a bond and the user may select particular bond attributes, as from a pull down menu. Information regarding the selected criteria and security may then be retrieved from the ETS database and/or an external data source. Other securities and associated attributes may also be selected in addition to those described herein. It should be noted that an embodiment of the ETS may be integrated with third-party trading systems as described in more detail elsewhere herein. In this instance, the user data entity 804 may be a proxy.

In this example, the selected bond criteria is represented as data entity 806. The bond criteria data entity 806 may include different bond attributes including, for example, a symbol an unique cusip identifier that may be used in performing trades, issuer information, and prices and quantities in connection with a history of trades for a specified time period within the ETS. Once the security criteria is selected as represented in the entity 806, a search or query may be performed of an instrument repository 808 that includes bond information, as well as other information on other securities and the like traded within the ETS. This may be within the ETS database and/or an external data source.

Data entity 808 identifies information that may be stored and/or obtained from an external as well as internal instrument repository as this information may be dynamic reflecting changing and current values in connection with ongoing trades. This information includes, for example, the highest and lowest bid in connection with trading for a particular security.

The instrument repository data entity 808 may maintain information in connection with one or more securities. In this example, information regarding the bond is represented in the data entity 812 as information, for example, that may be maintained in an external database or instrument repository.

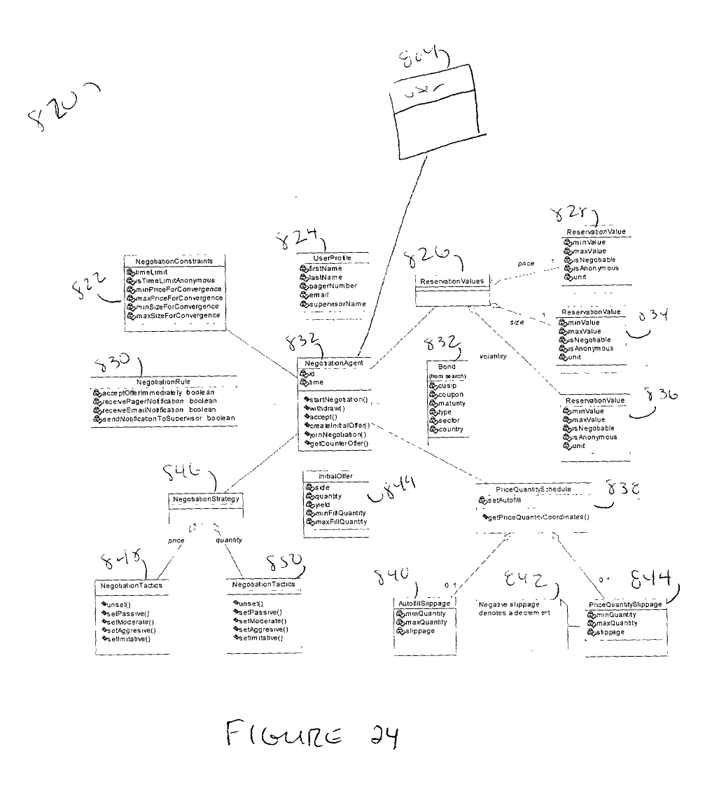

Referring now to FIG. 24, shown is a representation of an example of a class diagram of setting up a negotiation process for a user from FIG. 23 once a particular security has been selected. The negotiation agent 832 may represent a data entity associated with a particular user for negotiating a particular security within the Negotiation Engine. Information from the user profile 824, bond information 83, and other negotiation information that may entered, for example, in connection with screen shots or other user interfaces described elsewhere herein.

The negotiation constraints data entity 822 represents constraints for negotiation that may be entered by a user, for example, using interactive user interfaces described elsewhere herein. These may include, for example, time and size constraints. The negotiation rule data entity 830 may represent information in connection with user specified rules, such as notification in connection with transactions to be sent to particular e-mail address upon termination of a trade due to time-out, or if a transaction/trade is completed. Additionally, this may provide an option for user confirmation being required in connection with completing or accepting a particular offer, such as by a return e-mail response. An initial offer data entity 849 includes values for the initial offer as may be obtained from values entered by a user. Negotiation tactic data entities 848 and 850 correspond, respectively, to price and quantity tactics and strategies, such as aggressive, moderate and passive described elsewhere herein. The Negotiation Strategy entity 846 assists in determining the rate of concession with succeeding iterations of negotiations. For example, in one embodiment a passive mode signifies that the user is slow at making concessions. This may be specified, for example, when there is not an urgency associated with completing a particular trade. In contrast, the aggressive mode provides for rapid concessions in order to complete a trade sooner rather than later.

The negotiation agent 832 maintains and acts in accordance with information represented in other data entities in the representation 820. Different methods or actions associated with each agent 832 are also included in the representation, such as startNegotiation which takes the identifier of a counterparty's agent, and joinNegotiation to initially join the negotiation process for a particular security.

The price quantity schedule data entity 838 represents the data object for the coordinates of the intermediate points within the negotiation region for a particular offer.

Reservation values 826 determines the region or boundaries (using dimensions of price, quantity, size, and volatility) within which a negotiation session operates. An offer, or any portion thereof, outside this negotiation region is either accepted or rejected in accordance with its location. This negotiation region, and acceptance and reject regions as well, are described in more detail elsewhere herein. Reservation values, such as represented as entities 828, 834 and 836, represent individual reservation values as may be associated with a particular user.

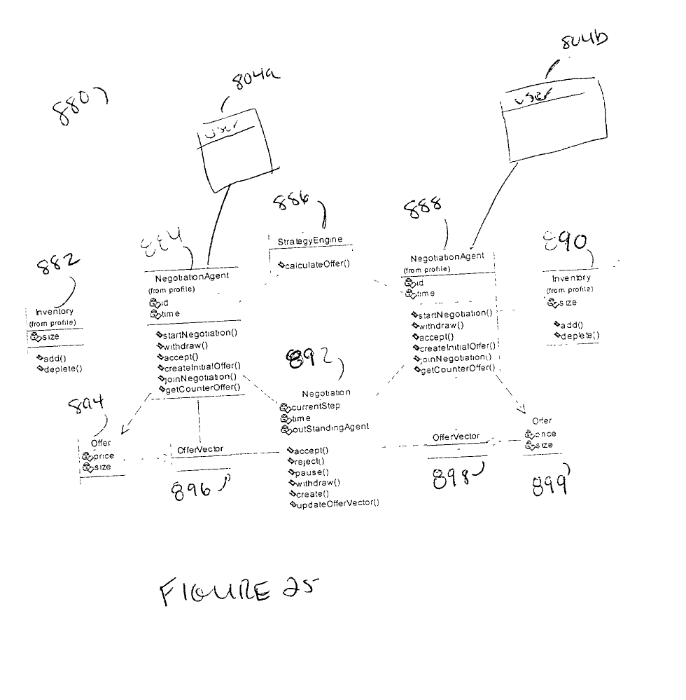

Data entities 840, 842 and 844 represents values used in connection with curve plotting. Autoslippage provides for generating a price/quantity schedule with a constant slope. Pricequantity slippage provides for a user specifying multiple points which provide for curve fitting customized to those points. Referring now to FIG. 25, shown is an example of a representation of a class diagram of the negotiation process. In other words, the representation 880 shows a snapshot of the data entities and relationships therebetween in one embodiment at a particular point in time. In this example, there are two users 804a and 804b each associated with their own agents, respectively 884 and 888. Both are negotiating with each other for a particular security. The negotiation is represented as the data entity 892, and offers and counteroffers are generated by the strategy engine data entity 886 in accordance with data input from the various agents 884 and 888. Recall that for a partial fill order, a plurality of data points may be used. For an ALL or NONE order, an offer and corresponding counteroffers may each include a single data point. Offers may be represented by data entities 896 and 898 and each associated with a particular agent acting on behalf of a user. An inventory data entity, such as 882 and 890, may represent the quantity adjustments to be made in accordance with accepting an counteroffer from an agent, or a portion of such a counteroffer.

The foregoing various data entities and relationships between them may be included within the ETS and/or within other external data sources. The database(s) may include any one or more of a variety of hardware and/or software combinations as described elsewhere herein.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method executed in a computer system for performing an electronic transaction comprising:
connecting, by a plurality of users, to an electronic trading system, each user being associated with a unique negotiation agent;
entering, by each of said plurality of users, at least one negotiation parameter;
selecting, by each of said plurality of users, at least one item in connection with the electronic transaction; and
automatically negotiating by the plurality of negotiation agents on behalf of said plurality of users for said at least one item, each of said plurality of agents automatically determining subsequent values for at least one negotiation parameter.

2. The method of claim 1, further comprising:
automatically determining an initial offer in accordance with said at least one negotiation parameter and said at least one item; and
receiving at least one counteroffer;
determining that at least a portion of a received counteroffer is acceptable.

3. The method of claim 2, further comprising:
requiring user approval of an acceptable counteroffer.

4. The method of claim 3, wherein said user approval is obtained by soliciting an electronic response.

5. The method of claim 1, further comprising:
updating said at least one negotiation parameter while negotiation process is ongoing.

6. The method of claim 5, further comprising:
selecting by a user to terminate the negotiation after negotiation processing has been initiated.

7. The method of claim 2, wherein said at least one negotiation parameter includes pricing information.

8. The method of claim 7, further comprising:
determining said initial offer using said at least one negotiation parameter that includes pricing information.

9. The method of claim 8, further comprising:
determining at least one index in connection with at least one counteroffer.

10. The method of claim 9, further comprising:
determining whether a received counteroffer is at least partially acceptable if one of said negotiation parameters indicates that this electronic transaction may be partially filled with multiple orders; and
determining whether a received counteroffer is one of completely rejected and completely accepted if one of said negotiation parameters indicates that this electronic transaction may be completely filled with a single order.

11. The method of claim 9, further comprising:
determining a response index representing a weighted average of all received counteroffers for one round;
determining a target index representing a proximity to desired target values indicated in said at least one negotiation parameter;
determining an offer index for each counteroffer representing for each counteroffer an indication of utility of the counteroffer; and
determining a counteroffer index in accordance with said response index, said target index, and said offer index.

12. The method of claim 11, wherein each of said response index, said target index, said offer index and said counteroffer index each represent a curve comprising a plurality of points if said at least one negotiation parameter indicates that said electronic transaction is a partial fill order.

13. The method of claim 11, wherein each of said response index, said target index, said offer index and said counteroffer index each represent a single point for a particular quantity if said at least one negotiation parameter indicates that said electronic transaction is an all or none order.

14. The method of claim 12, further comprising:
determining a counteroffer using the counteroffer index using reverse interpolation between a minimum and maximum price range specified in said at least one negotiation parameter.

15. The method of claim 14, wherein said counteroffer includes multiple points if said electronic transaction is a partial fill order, and wherein said counteroffer includes only a single point if said electronic transaction is an all or none type of order.

16. The method of claim 2, further comprising:
determining a negotiation region, an acceptable region and a rejection region in accordance with said at least one negotiation parameter; and
using said negotiation, acceptable, and rejection regions in determining whether to accept any portion of a received counteroffer.

17. The method of claim 16, further comprising:
representing said negotiation region, said acceptable region and said rejection region graphically as a two-dimensional figure if said electronic transaction is a partial fill order.

18. The method of claim 11, further comprising:
determining an offer using dynamic market information regarding said selected item, said dynamic market information reflecting current market conditions of said selected item in connection with trading of said selected item.

19. The method of claim 1, further comprising:
determining an initial offer;
receiving a plurality of counteroffers;
determining at least one index associated with each counteroffer; and
evaluating said plurality of counteroffers using said indices associated with each counteroffer.

20. The method of claim 19, wherein each index represents a curve of a plurality of points, each point being represented as a price and quantity.

21. The method of claim 1, further comprising:
determining an initial offer;
receiving a plurality of counteroffers; and
determining a customized counteroffer for each of said received counteroffers.

22. A computer program product for performing an electronic transaction comprising:
machine executable code for connecting, by a plurality of users, to an electronic trading system, each user being associated with a unique negotiation agent;
machine executable code for entering, by each of said plurality of users, at least one negotiation parameter;
machine executable code for selecting, by each of said plurality of users, at least one item in connection with the electronic transaction; and
machine executable code for automatically negotiating by the plurality of negotiation agents on behalf of said plurality of users for said at least one item, each of said plurality of agents automatically determining subsequent values for at least one negotiation parameter.

23. The computer program product of claim 22, further comprising:
machine executable code for automatically determining an initial offer in accordance with said at least one negotiation parameter and said at least one item; and
machine executable code for receiving at least one counteroffer; and
machine executable code for determining that at least a portion of a received counteroffer is acceptable.

24. The computer program product of claim 23, further comprising:
machine executable code for requiring user approval of an acceptable counteroffer.

25. The computer program product of claim 24, wherein said user approval is obtained by soliciting an electronic response.

26. The computer program product of claim 22, further comprising:
machine executable code for updating said at least one negotiation parameter while negotiation process is ongoing.

27. The computer program product of claim 26, further comprising:
machine executable code for selecting by a user to terminate the negotiation after negotiation processing has been initiated.

28. The computer program product of claim 23, wherein said at least one negotiation parameter includes pricing information.

29. The computer program product of claim 28, further comprising:
machine executable code for determining said initial offer using said at least one negotiation parameter that includes pricing information.

30. The computer program product of claim 29, further comprising:
machine executable code for determining at least one index in connection with at least one counteroffer.

31. The computer program product of claim 30, further comprising:
machine executable code for determining whether a received counteroffer is at least partially acceptable if one of said negotiation parameters indicates that this electronic transaction may be partially filled with multiple orders; and
machine executable code for determining whether a received counteroffer is one of completely rejected and completely accepted if one of said negotiation parameters indicates that this electronic transaction may be completely filled with a single order.

32. The computer program product of claim 30, further comprising:
machine executable code for determining a response index representing a weighted average of all received counteroffers for one round;
machine executable code determining a target index representing a proximity to desired target values indicated in said at least one negotiation parameter;
machine executable code for determining an offer index for each counteroffer representing for each counteroffer an indication of utility of the counteroffer; and
machine executable code for determining a counteroffer index in accordance with said response index, said target index, and said offer index.

33. The computer program product of claim 32, wherein each of said response index, said target index, said offer index and said counteroffer index each represent a curve comprising a plurality of points if said at least one negotiation parameter indicates that said electronic transaction is a partial fill order.

34. The computer program product of claim 32, wherein each of said response index, said target index, said offer index and said counteroffer index each represent a single point for a particular quantity if said at least one negotiation parameter indicates that said electronic transaction is an all or none order.

35. The computer program product of claim 33, further comprising:
machine executable code for determining a counteroffer using the counteroffer index using reverse interpolation between a minimum and maximum price range specified in said at least one negotiation parameter.

36. The computer program product of claim 35, wherein said counteroffer includes multiple points if said electronic transaction is a partial fill order, and wherein said counteroffer includes only a single point if said electronic transaction is an all or none type of order.

37. The computer program product of claim 23, further comprising:
machine executable code for determining a negotiation region, an acceptable region and a rejection region in accordance with said at least one negotiation parameter; and
machine executable code for using said negotiation, acceptable, and rejection regions in determining whether to accept any portion of a received counteroffer.

38. The computer program product of claim 37, further comprising:
machine executable code for representing said negotiation region, said acceptable region and said rejection region graphically as a two-dimensional figure if said electronic transaction is a partial fill order.

39. The computer program product of claim 32, further comprising:
machine executable code for determining an offer using dynamic market information regarding said selected item, said dynamic market information reflecting current market conditions of said selected item in connection with trading of said selected item.

40. The computer program product of claim 22, further comprising machine executable code for:
determining an initial offer;
receiving a plurality of counteroffers;
determining at least one index associated with each counteroffer; and
evaluating said plurality of counteroffers using said indices associated with each counteroffer.

41. The computer program product of claim 40, wherein each index represents a curve of a plurality of points, each point being represented as a price and quantity.

42. The computer program product of claim 22, further comprising machine executable code for:
determining an initial offer;
receiving a plurality of counteroffers; and
determining a customized counteroffer for each of said received counteroffers.
